(19) United States
(12) Patent Application Publication
(10) Pub. No.: US 2019/0066248 A1
(43) Pub. Date: Feb. 28, 2019

(54) METHOD AND SYSTEM FOR IDENTIFYING POTENTIAL FRAUD ACTIVITY IN A TAX RETURN PREPARATION SYSTEM TO TRIGGER AN IDENTITY VERIFICATION CHALLENGE THROUGH THE TAX RETURN PREPARATION SYSTEM

(71) Applicant: Intuit Inc., Mountain View, CA (US)

(72) Inventors: Kyle McEachern, San Diego, CA (US); Brent Rambo, San Diego, CA (US)

(73) Assignee: Intuit Inc., Mountain View, CA (US)

(21) Appl. No.: 15/686,435

(22) Filed: Aug. 25, 2017

(51) Int. Cl. G06Q 50/26; G06Q 40/00

(52) U.S. Cl. CPC G06Q 50/265; G06Q 40/123

(57) ABSTRACT

Special data sources and algorithms are used to analyze tax return data in order to identify potential fraudulent activity before the tax return data is submitted in a tax return preparation system. Then, once the potential fraudulent activity is identified, an identity verification challenge is generated through the tax return preparation system requiring a response from the user of the account associated with the potential fraudulent activity before the tax return data is submitted. Consequently, analysis of tax related data is performed to identify potential fraudulent activity in a tax return preparation system before the tax return related data is submitted. Then, if potential fraud is detected, a user of the tax return preparation system is required to further prove their identity before the tax return data is submitted.

### RELATED APPLICATIONS

The present application is related to previously filed application Ser. No. 15/220,714, attorney docket number INTU169880, entitled “METHOD AND SYSTEM FOR IDENTIFYING AND ADDRESSING POTENTIAL STOLEN IDENTIFY REFUND FRAUD ACTIVITY IN A FINANCIAL SYSTEM” filed in the name of Jonathan R. Goldman, Monica Tremont Hsu, Efraim Feinstein, and Thomas M. Pigoski II, on Jul. 27, 2016, which is incorporated herein, in its entirety, by this reference.

The present application is related to previously filed application Ser. No. 15/417,596, attorney docket number INTU1710231, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT” filed in the name of Kyle McEachern, Monica Tremont Hsu, and Brent Rambo on Jan. 27, 2017 which is incorporated herein, in its entirety, by this reference.

The present application is related to previously filed application Ser. No. 15/440,252, attorney docket number INTU1710232, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT AND TAX RETURN HISTORY” filed in the name of Kyle McEachern, Monica Tremont Hsu, and Brent Rambo on Feb. 23, 2017, which is incorporated herein, in its entirety, by this reference.

The present application is related to previously filed application Ser. No. 15/478,511, attorney docket number INTU1710233, entitled “METHOD AND SYSTEM FOR IDENTIFYING POTENTIAL FRAUD ACTIVITY IN A TAX RETURN PREPARATION SYSTEM, AT LEAST PARTIALLY BASED ON DATA ENTRY CHARACTERISTICS OF TAX RETURN CONTENT” filed in the name of Kyle McEachern and Brent Rambo on Apr. 4, 2017, which is incorporated herein, in its entirety, by this reference.

### BACKGROUND

Currently available tax return preparation systems are diverse and valuable data processing tools that provide tax preparation and filing services to users that were either never before available, or were previously available only through interaction with a human professional. Without tax return preparation systems, tax filers must consult with tax preparation professionals, i.e., humans, for preparation and filing of their tax documents. Consequently, absent a tax return preparation system, a tax filer is limited, and potentially inconvenienced, by the hours during which the tax professional is available for consultation. Furthermore, the tax filer might be required to travel to the professional's physical location. However, beyond the inconveniences of scheduling and travel, without tax return preparation systems, the tax filer is also at the mercy of the professional's education, skill, experience, personality, and various other human limitations/variables. Consequently, without tax return preparation systems, a tax filer is vulnerable to human and physical limitations, human error, variations in human ability, and variations in human temperament.

Tax return preparation systems provide tax filers significant flexibility and many advantages over services offered by human tax professionals, such as, but not limited to: 24-hour-a-day and 7-day-a-week availability; no geographical location restrictions or travel time; consistency, objectivity, and neutrality of experience and service; and minimization of human error and the impact of human limitations. Consequently, tax return preparation systems represent a potentially flexible, highly accessible, and affordable source of services.

However, like any data processing based system, tax return preparation systems also have increased vulnerabilities to various forms of data misappropriation and theft. One significant example is the potential vulnerability of sensitive user tax related information to malicious use and/or fabrication by third party perpetrators of fraud, i.e., “fraudsters.”

In the tax preparation environment, fraudsters, also referred to herein as tax cybercriminals, target tax return preparation systems to obtain money or financial credit using a variety of unethical techniques. For example, fraudsters can target tax return preparation systems to obtain tax refunds or tax credits of legitimate tax filers by using a combination of actual and fabricated information associated with legitimate tax filers to obtain tax refunds from one or more revenue agencies such as the Internal Revenue Service (IRS), and/or one or more state or local tax agencies. This exploitation of tax filers, tax related data, and tax return preparation systems is not only criminal, but the experience of being victimized by tax fraud can be relatively traumatic for users of the tax return preparation system. As a result, a given victim tax filer's personal bad experience can have a chilling effect on potential future use of a tax return preparation system by both the victim tax filer user and other potential users of the tax return preparation system. Consequently, the fraudulent use of tax return preparation systems is extremely problematic for tax revenue collection agencies, tax filers, and tax return preparation service providers.

One form of tax fraud commonly committed using tax return preparation systems is Stolen Identity Refund Fraud (“SIRF”). In a SIRF scheme, fraudsters obtain detailed information about the identity of a legitimate tax filer through various means such as identity theft phishing attacks (e.g., through deceitful links in email messages) or by purchasing identities using identity theft services in underground markets such as the “Dark Web.” Using a SIRF scheme, fraudsters then create fraudulent user accounts within a tax return preparation system using the stolen identity data. Since the fraudulent user accounts are created using identity data stolen from legitimate tax filers, the fraudulent user accounts may digitally appear to be legitimate and therefore can be extremely difficult to detect.

Given the exponential rise in computer data and identity theft, and significant impact of fraud perpetuated using tax return preparation systems, providers of tax return preparation systems are highly motivated to identify and/or prevent fraud perpetuated using their tax return preparation systems. However, the tax revenue collection and government agencies, such as the IRS, that are ultimately responsible for processing tax returns, and collecting taxes, have generated several rules and procedures that must be adhered to by the providers of tax return preparation systems to ensure that use of the tax return preparation systems does not interfere with, or unduly burden or slow down, the tax processing and collection process for either the tax filer or the revenue agency.

As a specific example, in order to comply with tax revenue collection and government agency regulations, some tax return preparation systems require that, once tax return data is submitted to the tax return preparation system, the tax return form/data must be submitted to the IRS within 72 hours. Therefore, even in cases where potential tax fraud is identified by a tax return preparation system provider, the potentially fraudulent tax return data is still submitted to the IRS within 72 hours. Consequently, the potential fraud must be identified, investigated, and resolved, within 72 hours. Clearly, this results in many identified potentially fraudulent tax returns being submitted to the IRS, despite known concerns regarding the legitimacy of the tax return data and/or the identity of the tax flier.

However, the situation is further complicated by the fact that the most common prior art solution for investigating identified potential tax return fraud is to generate and send one or more messages to the tax return data submitter, i.e., the user associated with the account, or an identifier such as a Social Security number, using email, text, or phone associated with the account, the user, or the identifier. Unfortunately, this mechanism often results in simply notifying the fraudster that they have been identified while not necessarily helping the victims of the fraud. In addition, even if the message reaches the legitimate tax filer, the message must be read and responded to within 72 hours. Again, this results in many identified potentially fraudulent tax returns being submitted to the IRS because there simply was not enough time for a legitimate filer to check their email, open the message, contact the proper party, such as the provider of the tax return preparation system or the IRS, and potentially clear up the issue, within the 72-hour limit.

In addition, current regulations imposed by tax revenue collection agencies, such as the IRS, prevent providers of tax return preparation systems from making any challenge to the submitted tax return data other than simply ensuring the identity of the submitter. That is to say, currently, tax return preparation system providers are not allowed to question the validity of the submitted tax return data itself or investigate fraud issues beyond ensuring the user of the tax return preparation system is who they say they are.

As a result of the situation described above, providers of tax return preparation systems, tax filers, and tax revenue collection agencies, currently all face the long standing technical problem of efficiently and reliably identifying potentially fraudulent activity and then preventing the identified potentially fraudulent data from being submitted while, at the same time, complying with tax return preparation service provider rules that have been mandated by federal and state tax revenue collection agencies.

### SUMMARY

The present disclosure addresses some of the short comings of prior art methods and systems by using special data sources and algorithms to analyze tax return data in order to identify potential fraudulent activity before the tax return data is submitted in a tax return preparation system. Then, once the potential fraudulent activity is identified, one or more identity verification challenges are generated and issued through the tax return preparation system. A correct response to identity verification challenge is then required from the user associated with the potential fraudulent activity before the tax return data is submitted.

Consequently, using embodiments disclosed herein, analysis of tax related data is performed to identify potential fraudulent activity in a tax return preparation system before the tax return related data is submitted. Then, if potential fraud is detected, a user of the tax return preparation system is required to further prove their identity before the tax return data is submitted. As a result, using embodiments disclosed herein, potentially fraudulent activity is challenged before the tax related data is submitted and therefore before rules regarding the processing of “submitted” tax data are triggered or take effect.

Consequently, using embodiments disclosed herein, a technical solution is provided to the long standing technical problem of efficiently and reliably identifying potentially fraudulent activity and then preventing the identified potentially fraudulent data from being submitted while, at the same time, complying with tax return preparation service provider rules that have been mandated by federal and state tax revenue collection agencies.

In one embodiment, one or more computing systems are used to provide a tax return preparation system to one or more users of the tax return preparation system. In one embodiment, the tax return preparation system is any tax return preparation system as discussed herein, and/or as known in the art at the time of filing, and/or as developed after the time of filing.

In one embodiment, one or more computing systems are used to obtain and store prior tax return content data associated with prior tax return data representing prior tax returns submitted by one or more users of the tax return preparation system.

In one embodiment, one or more computing systems are used to generate potential fraud analytics model data representing a potential fraud analytics model for determining a user potential fraud risk score to be associated with tax return content data included in tax return data representing tax returns associated with users of the tax return preparation system.

In one embodiment, potential fraudulent activity is identified based, at least partially, on potential fraudulent activity algorithms of a potential fraud analytics model applied to tax return content. In one embodiment, the tax return content associated with a user account within a tax return preparation system is obtained and provided to the analytics model which generates a user potential fraud risk score based on the tax return content. In addition, in one embodiment, the user potential fraud risk score is based, at least partially, on system access information that represents characteristics of the device used to file a tax return. Consequently, in one embodiment, the user potential fraud risk score represents a likelihood of potential fraud activity associated with tax return content data.

In one embodiment, potential fraudulent activity is identified based, at least partially, on potential fraudulent activity algorithms of a potential fraud analytics model applied to new tax return content and tax return history. In one embodiment, new tax return content of a new tax return associated with a tax filer identifier (e.g., Social Security Number) is compared to prior tax return content of one or more prior tax returns for the tax filer identifier. In one embodiment, a user potential fraud risk score is then generated based on the comparison. In one embodiment, the user potential fraud risk score is determined based, at least partially, on applying the new tax return content of the new tax return and the prior tax return content of one or more prior tax returns to an analytics model. In addition, in one embodiment, the user potential fraud risk score is determined based, at least partially, on applying system access information to an analytics model. In one embodiment, the system access information represents characteristics of the device used to file the new tax return. Consequently, in one embodiment, the user potential fraud risk score represents a likelihood of potential fraud activity associated with new user tax returns associated with the tax filer identifier that is determined, based, at least partially, on tax return history for the tax filer identifier.

In one embodiment, the potential fraudulent activity is identified based, at least partially, on potential fraudulent activity algorithms of a potential fraud analytics model applied to data entry characteristics of tax return content provided to the tax return preparation system by users of the tax return preparation system. In one embodiment, new tax return content of a new tax return associated with a tax filer identifier (e.g., Social Security Number) is compared to the prior data entry characteristics of prior tax return content of one or more prior tax returns entered into the tax return preparation system. In one embodiment, a user potential fraud risk score is determined based on the comparison. In one embodiment, the user potential fraud risk score is determined based on applying the new data entry characteristics of new tax return content of a new tax return to an analytics model. In one embodiment, the user potential fraud risk score is determined, at least partially, on applying system access information to an analytics model. In one embodiment, the system access information represents characteristics of the device used to file the new tax return. Consequently, in one embodiment, the user potential fraud risk score represents a likelihood of potential fraud activity associated with the tax return for the tax filer identifier that is determined, based, at least partially, on the user data entry characteristics for the tax return.

In one embodiment, the user potential fraud risk score is determined by any method, means, system, or mechanism for determining a user potential fraud risk score, as discussed herein, and/or as known in the art at the time of filing, and/or as developed after the time of filing, and represents a likelihood of potential fraud activity associated with the tax return for the tax filer identifier based, at least partially, on any analysis factors desired, as discussed herein, and/or as known in the art at the time of filing, and/or as developed after the time of filing.

In one embodiment, once a user potential fraud risk score is determined, one or more computing systems are used to generate user potential fraud risk score data representing the determined user potential fraud risk score.

In one embodiment, one or more computing systems are used to compare the user potential fraud risk score represented by the user potential fraud risk score data to a defined threshold user potential fraud risk score represented by user potential fraud risk score threshold data to determine if the user potential fraud risk score exceeds a user potential fraud risk score threshold.

In one embodiment, one or more computing systems are used to determine the user potential fraud risk score exceeds the user potential fraud risk score threshold.

In one embodiment, one or more computing systems are used to generate user identity verification challenge data representing one or more identity verification challenges to be provided to the user through the tax return preparation system. In one embodiment, the one or more identity verification challenges require correct identity verification challenge response data from the user representing correct responses to the identity verification challenges.

In various embodiments, the identity verification challenges include, but are not limited to, one or more of: requests to identify or submit historical or current residences occupied by the legitimate account holder/user; requests to identify or submit one or more historical or current loans or credit accounts associated with the legitimate account holder/user; requests to identify or submit full or partial names of relatives associated with the legitimate account holder/user; requests to identify or submit recent financial activity conducted by the legitimate account holder/user; requests to identify or submit phone numbers or social media account related information associated with the legitimate account holder/user; requests to identify or submit full or partial names of relatives associated with the legitimate account holder/user; requests to identify or submit current or historical automobile, teacher, pet, friend, or nickname information associated with the legitimate account holder/user; any Multi-Factor Authentication (MFA) challenge such as, but not limited to, text message or phone call verification; and/or any other identity verification challenge, as discussed herein, and/or as known in the art at the time of filing, and/or as developed/made available after the time of filing.

In various embodiments, the correct responses to the identity verification challenges, i.e., the correct identity verification challenge response data, is obtained prior to the identity verification challenge data being generated and issued. In various embodiments, the correct responses to the identity verification challenges, i.e., the correct identity verification challenge response data, is obtained from the legitimate user account holder prior to the identity verification challenge data being generated and issued from the legitimate user/account holder. In various embodiments, the correct responses to the identity verification challenges, i.e., the correct identity verification challenge response data, is obtained from analysis of historical tax return data associated with the legitimate user/account holder prior to the identity verification challenge data being generated and issued. In various embodiments, the correct responses to the identity verification challenges, i.e., the correct identity verification challenge response data, is obtained from any source of correct identity verification challenge response data as discussed herein, and/or as known in the art at the time of filing, and/or as developed/made available after the time of filing.

In one embodiment, one or more computing systems are used to provide the user identity verification challenge data to the user through the tax return preparation system.

In one embodiment, one or more computing systems are used to delay submission of the user tax return data until correct identity verification challenge response data is received from the user representing correct responses to the identity verification challenges.

In one embodiment, only upon receiving correct identity verification challenge response data from the user representing correct responses to the identity verification challenges, are one or more computing systems used to allow submission of the user tax return data representing the user tax return associated with the user tax return data.

Consequently, using embodiments disclosed herein, analysis of tax related data is performed to identify potential fraudulent activity in a tax return preparation system before the tax return related data is submitted. Then, if potential fraud is detected, a user of the tax return preparation system is required to further prove their identity before the tax return data is submitted. As a result, using embodiments disclosed herein, potentially fraudulent activity is challenged before the tax related data is submitted and therefore before rules regarding the processing of “submitted” tax data are triggered or take effect.

Therefore, using embodiments disclosed herein, a technical solution is provided to the long standing and Internet-centric technical problem of efficiently and reliably identifying potentially fraudulent activity and then preventing the identified potentially fraudulent data from being submitted while, at the same time, complying with tax return preparation service provider rules that have been mandated by federal and state tax revenue collection agencies.

The disclosed embodiments do not represent an abstract idea for at least a few reasons. First, identifying potential fraud activity in a tax return preparation system to trigger an identity verification challenge is not an abstract idea because it is not merely an idea itself (e.g., cannot be performed mentally or using pen and paper), and requires the use of special data sources and data processing algorithms. Indeed, some of the disclosed embodiments include applying data representing tax return content to analytics models to determine data representing user potential fraud risk scores, which cannot be performed mentally.

Second, identifying potential fraud activity in a tax return preparation system to trigger an identity verification challenge is not an abstract idea because it is not a fundamental economic practice (e.g., is not merely creating a contractual relationship, hedging, mitigating a settlement risk, etc.).

Third, identifying potential fraud activity in a tax return preparation system to trigger an identity verification challenge is not an abstract idea because it is not a method of organizing human activity (e.g., managing a game of bingo).

Fourth, although, in one embodiment, mathematics may be used to generate an analytics model, identifying potential fraud activity in a tax return preparation system to trigger an identity verification challenge is not simply a mathematical relationship/formula, but is instead a technique for transforming data representing tax return content and system access information into data representing a user potential fraud risk score which quantifies the likelihood that a tax return is being fraudulently prepared or submitted.

In addition, generating identity verification challenge data in response to a determined threshold level of fraud risk, delivering the identity verification challenge data to a user of a tax return preparation system, receiving identity verification response data from the user, and then analyzing the correctness of identity verification response data, all through the tax return preparation system, is neither merely an idea itself, a fundamental economic practice, a method of organizing human activity, nor simply a mathematical relationship/formula.

Further, identifying potential fraud activity in a tax return preparation system to trigger an identity verification challenge allows for significant improvement to the technical fields of information security, fraud detection, and tax return preparation systems. In addition, the present disclosure adds significantly to the field of tax return preparation systems by reducing the risk of victimization in tax return filings and by increasing tax return preparation system users' trust in the tax return preparation system. This reduces the likelihood of users seeking other less efficient techniques (e.g., via a spreadsheet, or by downloading individual tax return data) for preparing and filing their tax returns.

As a result, embodiments of the present disclosure allow for reduced use of processor cycles, processor power, communications bandwidth, memory, and power consumption, by reducing the number of users who utilize inefficient tax return preparation techniques, by efficiently and effectively reducing the amount of fraudulent data processed, and by reducing the number of instances of false positives for fraudulent activity. Consequently, computing and communication systems implementing or providing the embodiments of the present disclosure are transformed into more operationally efficient devices and systems.

In addition to improving overall computing performance, identifying potential fraud activity in a tax return preparation system to trigger an identity verification challenge helps maintain or build trust and therefore loyalty in the tax return preparation system, which results in repeat customers, efficient delivery of tax return preparation services, and reduced abandonment of use of the tax return preparation system.

### BRIEF DESCRIPTION OF THE DRAWINGS

FIG. 1 is a block diagram of software architecture production environment for identifying potential fraud activity in a tax return preparation system to trigger an identity verification challenge through the tax return preparation system, in accordance with one embodiment; and

FIG. 2 is a flow diagram of a process for identifying potential fraud activity in a tax return preparation system to trigger an identity verification challenge through the tax return preparation system, in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, or described below. Rather, these exemplary embodiments are provided to allow a complete disclosure that conveys the principles of the invention, as set forth in the claims, to those of skill in the art.

As used herein, the term data management system (e.g., a tax return preparation system or other software system) includes, but is not limited to the following: one or more of computing system implemented, online, web-based personal and business tax return preparation system; one or more of computing system implemented, online, web-based personal or business financial management systems, services, packages, programs, modules, or applications; one or more of computing system implemented, online, and web-based personal or business management systems, services, packages, programs, modules, or applications; one or more of computing system implemented, online, and web-based personal or business accounting or invoicing systems, services, packages, programs, modules, or applications; and various other personal or business electronic data management systems, services, packages, programs, modules, or applications, whether known at the time of filing or as developed after the time of filing.

Specific examples of data management systems include financial management systems. Examples of financial management systems include, but are not limited to the following: TurboTax® available from Intuit®, Inc. of Mountain View, Calif.; TurboTax Online™ available from Intuit®, Inc. of Mountain View, Calif.; QuickBooks®, available from Intuit®, Inc. of Mountain View, Calif.; QuickBooks Online™, available from Intuit®, Inc. of Mountain View, Calif.; Mint®, available from Intuit®, Inc. of Mountain View, Calif.; Mint® Online, available from Intuit®, Inc. of Mountain View, Calif.; or various other systems discussed herein, or known to those of skill in the art at the time of filing, or as developed after the time of filing.

As used herein the term “tax return preparation system” is a financial management system that receives personal, business, and financial information from tax filers (or their representatives) and prepares tax returns for the tax filers.

As used herein, the terms “computing system,” “computing device,” and “computing entity,” include, but are not limited to, the following: a server computing system; a workstation; a desktop computing system; a mobile computing system, including, but not limited to, one or more of smart phones, portable devices, and devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes or operations as described herein.

In addition, as used herein, the terms “computing system”, “computing entity”, and “computing environment” can denote, but are not limited to the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes or operations as described herein.

Herein, the term “production environment” includes the various components, or assets, used to deploy, implement, access, and use, a given system as that system is intended to be used. In various embodiments, production environments include multiple computing systems or assets that are combined, communicatively coupled, virtually or physically connected, or associated with one another, to provide the production environment implementing the application.

As specific illustrative examples, the assets making up a given production environment can include, but are not limited to, the following: one or more computing environments used to implement at least part of a system in the production environment such as a data center, a cloud computing environment, a dedicated hosting environment, or one or more other computing environments in which one or more assets used by the application in the production environment are implemented; one or more computing systems or computing entities used to implement at least part of a system in the production environment; one or more virtual assets used to implement at least part of a system in the production environment; one or more supervisory or control systems, such as hypervisors, or other monitoring and management systems used to monitor and control assets or components of the production environment; one or more communications channels for sending and receiving data used to implement at least part of a system in the production environment; one or more access control systems for limiting access to various components of the production environment, such as firewalls and gateways; one or more traffic or routing systems used to direct, control, or buffer data traffic to components of the production environment, such as routers and switches; one or more communications endpoint proxy systems used to buffer, process, or direct data traffic, such as load balancers or buffers; one or more secure communication protocols or endpoints used to encrypt/decrypt data, such as Secure Sockets Layer (SSL) protocols, used to implement at least part of a system in the production environment; one or more databases used to store data in the production environment; one or more internal or external services used to implement at least part of a system in the production environment; one or more backend systems, such as backend servers or other hardware used to process data and implement at least part of a system in the production environment; one or more modules/functions used to implement at least part of a system in the production environment; or any other assets/components making up an actual production environment in which at least part of a system is deployed, implemented, accessed, and run, e.g., operated, as discussed herein, or as known in the art at the time of filing, or as developed after the time of filing.

As used herein, the term “computing environment” includes, but is not limited to, a logical or physical grouping of connected or networked computing systems or virtual assets using the same infrastructure and systems such as, but not limited to, hardware systems, systems, and networking/communications systems. Typically, computing environments are either known, “trusted” environments or unknown, “untrusted” environments. Typically, trusted computing environments are those where the assets, infrastructure, communication and networking systems, and security systems associated with the computing systems or virtual assets making up the trusted computing environment, are either under the control of, or known to, a party.

In various embodiments, each computing environment includes allocated assets and virtual assets associated with, and controlled or used to create, deploy, or operate at least part of the system.

In various embodiments, one or more cloud computing environments are used to create, deploy, or operate at least part of the system that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, as known in the art at the time of filing, or as developed after the time of filing.

In many cases, a given system or service may utilize, and interface with, multiple cloud computing environments, such as multiple VPCs, in the course of being created, deployed, or operated.

As used herein, the term “virtual asset” includes any virtualized entity or resource, or virtualized part of an actual, or “bare metal” entity. In various embodiments, the virtual assets can be, but are not limited to, the following: virtual machines, virtual servers, and instances implemented in a cloud computing environment; databases associated with a cloud computing environment, or implemented in a cloud computing environment; services associated with, or delivered through, a cloud computing environment; communications systems used with, part of, or provided through a cloud computing environment; or any other virtualized assets or sub-systems of “bare metal” physical devices such as mobile devices, remote sensors, laptops, desktops, point-of-sale devices, etc., located within a data center, within a cloud computing environment, or any other physical or logical location, as discussed herein, or as known/available in the art at the time of filing, or as developed/made available after the time of filing.

In various embodiments, any, or all, of the assets making up a given production environment discussed herein, or as known in the art at the time of filing, or as developed after the time of filing can be implemented as one or more virtual assets within one or more cloud or traditional computing environments.

In one embodiment, two or more assets, such as computing systems or virtual assets, or two or more computing environments are connected by one or more communications channels including but not limited to, Secure Sockets Layer (SSL) communications channels and various other secure communications channels, or distributed computing system networks, such as, but not limited to the following: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, or virtual assets, as discussed herein, or available or known at the time of filing, or as developed after the time of filing.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, or computing systems, whether available or known at the time of filing or as later developed.

As used herein, the term “user experience display” includes not only data entry and question submission user interfaces, but also other user experience features and elements provided or displayed to the user such as, but not limited to, the following: data entry fields, question quality indicators, images, backgrounds, avatars, highlighting mechanisms, icons, buttons, controls, menus and any other features that individually, or in combination, create a user experience, as discussed herein, or as known in the art at the time of filing, or as developed after the time of filing.

As used herein, the term “user experience” includes, but is not limited to, one or more of a user session, interview process, interview process questioning, or interview process questioning sequence, or other user experience features provided or displayed to the user such as, but not limited to, interfaces, images, assistance resources, backgrounds, avatars, highlighting mechanisms, icons, and any other features that individually, or in combination, create a user experience, as discussed herein, or as known in the art at the time of filing, or as developed after the time of filing.

Herein, the term “party,” “user,” “user consumer,” and “customer” are used interchangeably to denote any party or entity that interfaces with, or to whom information is provided by, the disclosed methods and systems described herein, or a legal guardian of person or entity that interfaces with, or to whom information is provided by, the disclosed methods and systems described herein, or an authorized agent of any party or person or entity that interfaces with, or to whom information is provided by, the disclosed methods and systems described herein. For instance, in various embodiments, a user can be, but is not limited to, a person, a commercial entity, an application, a service, or a computing system.

As used herein, the term “analytics model” denotes one or more individual or combined algorithms or sets of ordered relationships that describe, determine, or predict characteristics of or the performance of a datum, a data set, multiple data sets, a computing system, or multiple computing systems. Analytics models or analytical models represent collections of measured or calculated behaviors of attributes, elements, or characteristics of data or computing systems. Analytics models include predictive models, which identify the likelihood of one attribute or characteristic based on one or more other attributes or characteristics.

As used herein a “user potential fraud risk score” quantifies or metricizes (i.e., makes measurable) the amount of risk calculated to be associated with a tax return, with the computing system that is used to prepare the tax return, or with the user of the tax return preparation system that is providing information for the preparation of the tax return.

As used herein “tax return content” denotes user (person or business) characteristics and financial information for a tax filer, according to various embodiments.

As used herein the term “system access information” denotes data that represents the activities of a user during the user's interactions with a tax return preparation system, and represents system access activities and the features or characteristics of those activities, according to various embodiments.

As used herein, the term “risk categories” denotes characteristics, features, or attributes of tax return content, users, or client computing systems, and represents subcategories of risk that may be transformed into a user potential fraud risk score to quantify potentially fraudulent activity, according to various embodiments.

As used herein, the term “stolen identity refund fraud” (“SIRF”) denotes a creation of a tax return preparation system account using a tax filer identifier (e.g., name, birth date, Social Security Number, etc.) of an owner (e.g., person, business, or other entity) without the permission of the owner of the tax filer identifier. Stolen identity refund fraud is one technique that is employed by cybercriminals to obtain tax refunds from state and federal revenue agencies.

As used herein, the term identity verification challenges includes, but is not limited to, one or more of: requests to identify or submit historical or current residences occupied by the legitimate account holder/user; requests to identify or submit one or more historical or current loans or credit accounts associated with the legitimate account holder/user; requests to identify or submit full or partial names of relatives associated with the legitimate account holder/user; requests to identify or submit recent financial activity conducted by the legitimate account holder/user; requests to identify or submit phone numbers or social media account related information associated with the legitimate account holder/user; requests to identify or submit full or partial names of relatives associated with the legitimate account holder/user; requests to identify or submit current or historical automobile, teacher, pet, friend, or nickname information associated with the legitimate account holder/user; any Multi-Factor Authentication (MFA) challenge such as, but not limited to, text message or phone call verification; and/or any other identity verification challenge, as discussed herein, and/or as known in the art at the time of filing, and/or as developed/made available after the time of filing.

### Hardware Architecture

The systems and methods of the present disclosure provide techniques for identifying and preventing potential stolen identity refund fraud in a financial system to protect users' accounts, even if victims/users have unwittingly provided fraudsters with the victims'/users' identity information themselves.

In addition, sometimes a fraudulent tax return is difficult to detect because the fraudulently provided information does not, on its own, appear unreasonable. However, the systems and methods of the present disclosure provide techniques for identifying and addressing potential stolen identity refund fraud in a financial system to protect users' accounts, again even if users/victims have unwittingly provided the fraudsters with the users'/victims' identity information, according to one embodiment.

To this end, using embodiments disclosed herein, analysis of tax related data is performed to identify potential fraudulent activity in a tax return preparation system before the tax return related data is submitted. Then, if potential fraud is detected, a user of the tax return preparation system is required to further prove their identity before the tax return data is submitted. As a result, using embodiments disclosed herein, potentially fraudulent activity is challenged before the tax related data is submitted and therefore before rules regarding the processing of “submitted” tax data are triggered or take effect.

Therefore, using embodiments disclosed herein, a technical solution is provided to the long standing technical problem of efficiently and reliably identifying potentially fraudulent activity and then preventing the identified potentially fraudulent data from being submitted while, at the same time, complying with tax return preparation service provider rules that have been mandated by federal and state tax revenue collection agencies.

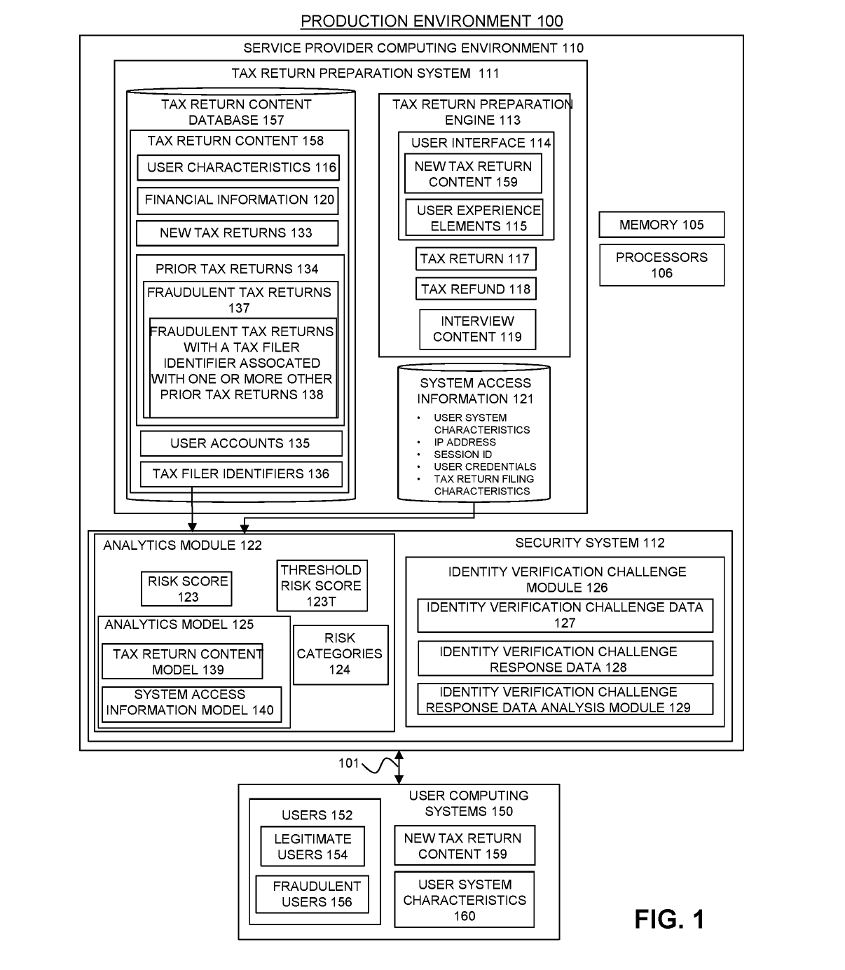

FIG. 1 is an example block diagram of a production environment 100 for identifying potential fraud activity in a tax return preparation system to trigger an identity verification challenge through the tax return preparation system. The production environment 100 includes a service provider computing environment 110 and user computing systems 150. In one embodiment, the service provider computing environment 110 includes a tax return preparation system 111 and a security system 112 for identifying potential fraud activity in the tax return preparation system 111. The service provider computing environment 110 is communicatively coupled to the user computing systems 150 over a communications channel 101. The communications channel 101 represents one or more local area networks, the Internet, or a combination of one or more local area networks and the Internet, according to various embodiments.

In one embodiment, the tax return preparation system 111 and the security system 112 determine a level of risk (e.g., a user potential fraud risk score) that is associated with a tax return, based on tax return content of the tax return and/or based on tax return history.

In various embodiments, the techniques for determining the level of risk or the user potential fraud risk score for a tax return include the techniques disclosed in related previously filed application Ser. No. 15/220,714, attorney docket number INTU169880, entitled “METHOD AND SYSTEM FOR IDENTIFYING AND ADDRESSING POTENTIAL STOLEN IDENTIFY REFUND FRAUD ACTIVITY IN A FINANCIAL SYSTEM” filed in the name of Jonathan R. Goldman, Monica Tremont Hsu, Efraim Feinstein, and Thomas M. Pigoski II, on Jul. 27, 2016, which is incorporated herein, in its entirety, by reference.

In various embodiments, the techniques for determining the level of risk or the user potential fraud risk score for a tax return include the techniques disclosed in related previously filed application Ser. No. 15/417,596, attorney docket number INTU1710231, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT” filed in the name of Kyle McEachern, Monica Tremont Hsu, and Brent Rambo on Jan. 27, 2017 which is incorporated herein, in its entirety, by reference.

In various embodiments, the techniques for determining the level of risk or the user potential fraud risk score for a tax return include the techniques disclosed in related previously filed application Ser. No. 15/440,252, attorney docket number INTU1710232, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT AND TAX RETURN HISTORY” filed in the name of Kyle McEachern, Monica Tremont Hsu, and Brent Rambo on Feb. 23, 2017, which is incorporated herein, in its entirety, by reference

In various embodiments, the techniques for determining the level of risk or the user potential fraud risk score for a tax return include the techniques disclosed in related previously filed application Ser. No. 15/478,511, attorney docket number INTU1710233, entitled “METHOD AND SYSTEM FOR IDENTIFYING POTENTIAL FRAUD ACTIVITY IN A TAX RETURN PREPARATION SYSTEM, AT LEAST PARTIALLY BASED ON DATA ENTRY CHARACTERISTICS OF TAX RETURN CONTENT” filed in the name of Kyle McEachern and Brent Rambo on Apr. 4, 2017, which is incorporated herein, in its entirety, by reference.

In one embodiment, the user computing systems 150 represent one or more user computing systems that are used by users 152 to access services that are provided by the service provider computing environment 110. In one embodiment, the users 152 include legitimate users 154 and fraudulent users 156. In one embodiment, the legitimate users 154 are tax filers who access the tax return preparation system 111, which is hosted by the service provider computing environment 110, to legally prepare, submit, and file a tax return 117. Fraudulent users 156 are users who illegally use tax filer identifiers or other information belonging to other people or entities to prepare and submit a tax return.

In one embodiment, the users 152 interact with the tax return preparation system 111 to provide new tax return content 159 to the tax return preparation system 111, for addition to tax return content 158 that is stored and maintained by the tax return preparation system 111. In one embodiment, the new tax return content 159 is represented by tax return content data. In one embodiment, the new tax return content 159 includes user characteristics 116 and financial information 120 that is provided to the tax return preparation system 111 to facilitate preparing a tax return. While, in one embodiment, the users 152 interact with the tax return preparation system 111, the tax return preparation system 111 collects user system characteristics 160 that are associated with the users 152. In one embodiment, one or more of the tax return content 158 and the user system characteristics 160 are used by the tax return preparation system 111 or by the security system 112 to at least partially determine a user potential fraud risk score 123 for a tax return 117.

In one embodiment, the service provider computing environment 110 provides the tax return preparation system 111 and the security system 112 to enable the users 152 to conveniently file tax returns, and to identify and reduce the risk of fraudulent tax return filings. In one embodiment, the tax return preparation system 111 progresses users through a tax return preparation interview to acquire new tax return content 159, to prepare tax returns 117 for users 152, and to assist users in obtaining tax credits or tax refunds 118. In one embodiment, the security system 112 uses tax return content, new tax return content, prior tax return content, and other information collected about the users 152 and about the user computing systems 150 to determine a user potential fraud risk score 123 for each new tax return 117 prepared with the tax return preparation system 111.

As discussed in more detail below, the analytics model 125 of analytics module 122 generates the user potential fraud risk score 123. In one embodiment, the user potential fraud risk score 123 is processed to determine if the user potential fraud risk score 123 for a particular new tax return 117 is indicative of fraudulent activity.

As also discussed in more detail below, in one embodiment, if the security system 112 determines that the user potential fraud risk score 123 for a particular new tax return is indicative of fraudulent activity, e.g., if the user potential fraud risk score exceeds a threshold risk score 123T, the security system 112 uses identity verification challenge module 126 to generate identity verification challenge data 127.

In one embodiment, the tax return preparation system 111 uses a tax return preparation engine 113 to facilitate preparing tax returns 117 for users. In one embodiment, the tax return preparation engine 113 provides a user interface 114, by which the tax return preparation engine 113 delivers user experience elements 115 to users to facilitate receiving the new tax return content 159 from the users 152. In one embodiment, the tax return preparation engine 113 uses the new tax return content 159 to prepare a tax return 117, and to assist users in obtaining a tax refund 118 from one or more state and federal revenue agencies (when applicable). In one embodiment, the tax return preparation engine 113 updates the tax return content 158 to include the new tax return content 159, while or after the new tax return content 159 is received by the tax return preparation system 111. In one embodiment, the tax return preparation engine 113 populates the user interface 114 with user experience elements 115 that are selected from interview content 119. The interview content 119 includes questions, tax topics, content sequences, and other user experience elements for progressing users through a tax return preparation interview, to facilitate the preparation of the tax return 117 for each user.

In one embodiment, the tax return preparation system 111 stores the tax return content 158 in a tax return content database 157, for use by the tax return preparation system 111 and for use by the security system 112. The tax return content 158 is a table, database, or other data structure. In one embodiment, the tax return content 158 includes user characteristics 116 and financial information 120.

In one embodiment, the user characteristics 116 are represented by user characteristics data and the financial information 120 is represented by financial information data. In one embodiment, the user characteristics 116 and the financial information 120 are personally identifiable information (“PII”). In one embodiment, the user characteristics 116 and the financial information 120 include, but are not limited to, data representing: type of web browser, type of operating system, manufacturer of computing system, whether the user's computing system is a mobile device or not, a user's name, a Social Security number, government identification, a driver's license number, a date of birth, an address, a zip code, a home ownership status, a marital status, an annual income, a job title, an employer's address, spousal information, children's information, asset information, medical history, occupation, information regarding dependents, salary and wages, interest income, dividend income, business income, farm income, capital gain income, pension income, individual retirement account (“IRA”) distributions, unemployment compensation, education expenses, health savings account deductions, moving expenses, IRA deductions, student loan interest deductions, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, account identifiers, bank accounts, prior tax returns, the financial history of users of the tax return preparation system 111, and any other information that is currently used, that can be used, or that may be used in the future, in a tax return preparation system or in providing one or more tax return preparation services, according to various embodiments. According to one embodiment, the security system 112 uses one or more of the user characteristics 116 and the financial information 120 of a new tax return and of one or more prior tax returns 134 to determine a likelihood that a new tax return is fraudulent, even if characteristics of a user computing system are not indicative of potential fraud.

In one embodiment, the new tax returns 133 represent tax returns that have not been filed by the tax return preparation system 111 with a state or federal revenue agency. In one embodiment, the new tax returns 133 are associated with portions of the tax return content 158 (e.g., the new tax return content 159) that have not been filed by the tax return preparation system 111 with a state or federal revenue agency. In one embodiment, the new tax returns 133 are tax returns that the users 152 are in the process of completing, either in a single user session or in multiple user sessions with the tax return preparation system 111, according to various embodiments. In one embodiment, the new tax returns 133 are tax returns that the users 152 have submitted to the tax return preparation system 111 for filing with one or more state and federal revenue agencies and that the tax return preparation system 111 has not filed with a state or federal revenue agency.

In one embodiment, each of the new tax returns 133 are prepared within the tax return preparation system 111 with one of the user accounts 135.

In one embodiment, each of the new tax returns 133 is associated with one or more of the tax filer identifiers 136. Examples of tax filer identifiers 136 include, but are not limited to, a Social Security Number (“SSN”), an Individual Taxpayer Identification Number (“ITIN”), an Employer Identification Number (“EIN”), an Internal Revenue Service Number (“IRSN”), a foreign tax identification number, a name, a date of birth, a passport number, a driver's license number, a green card number, and a visa number, according to various embodiments.

In one embodiment, one or more of the tax filer identifiers 136 are provided by the users 152 (e.g., within the new tax return content 159) while preparing the new tax returns 133. In one embodiment, a single one of the tax filer identifiers 136 can be used with multiple ones of the user accounts 135. For example, one of the legitimate users 154 can create one of the user accounts 135 with his or her SSN one year and then create another one of the user accounts 135 in a subsequent year (e.g., because the user forgot his or her credentials). As a problematic example, one of the legitimate users 154 can create one of the user accounts 135 with his or her SSN one year, and one of the fraudulent users 156 can create another (i.e., fraudulent) one of the user accounts 135 in a subsequent year using the same SSN (which is what the security system 112 is configured to identify and address).

In one embodiment, the prior tax returns 134 represent tax returns that have been filed by the tax return preparation system 111 with one or more state and federal revenue agencies. In one embodiment, the prior tax returns 134 are associated with portions of the tax return content 158 (e.g., prior tax return content) that was one or more of received by and filed by the tax return preparation system 111 with one or more state and federal revenue agencies. In one embodiment, one or more of the prior tax returns 134 are imported into the tax return preparation system 111 from one or more external sources, e.g., a tax return preparation system provided by another service provider. In one embodiment, the prior tax returns 134 are tax returns that the users 152 prepared in one or more prior years (with reference to a present year).

In one embodiment, the prior tax returns 134 include a subset of tax returns that are fraudulent tax returns 137. The fraudulent tax returns 137 are tax returns that were identified as being fraudulent by one or more legitimate users 154 to the service provider of the tax return preparation system 111. In one embodiment, the fraudulent tax returns 137 are tax returns that were identified as being fraudulent by one or more state and federal revenue agencies (e.g., in a fraudulent tax return filing report). At least some of the fraudulent tax returns 137 have been filed with one or more state and federal revenue agencies by the tax return preparation system 111.

In one embodiment, a subset of the fraudulent tax returns 137 are fraudulent tax returns with a tax filer identifier associated with one or more other prior tax returns 138. In one embodiment, the fraudulent tax returns with a tax filer identifier associated with one or more other prior tax returns 138 are used by the security system 112 as a training data set of tax return content that is used to train an analytics model to detect potential fraud activity within the new tax returns 133. In one embodiment, the fraudulent tax returns with a tax filer identifier associated with one or more other prior tax returns 138 are tax returns that have been identified as being fraudulent and that use a tax filer identifier (e.g., SSN) that was used to file one or more prior (e.g., non-fraudulent) tax returns. In one embodiment, the analytics model that is trained from this training data set is adapted to identify inconsistencies between prior tax returns and a new tax return that are indicative of potential fraud activity.

In one embodiment, each of the prior tax returns 134 are associated with one of the user accounts 135. In one embodiment, each of the prior tax returns 134 are associated with one of the user accounts 135 that was used to prepare the prior tax returns 134 within the tax return preparation system 111. In one embodiment, one or more of the prior tax returns 134 have tax return content that is imported into the tax return preparation system 111 after having been filed with one or more state and federal revenue agencies, and was not prepared and filed with the tax return preparation system 111.

In one embodiment, each of the prior tax returns 134 is associated with one or more of the tax filer identifiers 136.

In one embodiment, the tax return preparation system 111 acquires and stores system access information 121 in a table, database, or other data structure, for use by the tax return preparation system 111 and for use by the security system 112. In one embodiment, the system access information 121 includes, but is not limited to, data representing one or more of: user system characteristics, IP addresses, tax return filing characteristics, user account characteristics, session identifiers, and user credentials. In one embodiment, the system access information 121 is defined based on the user system characteristics 160. In one embodiment, the user system characteristics 160 include one or more of an operating system, a hardware configuration, a web browser, information stored in one or more cookies, the geographical history of use of a user computing system, an IP address, and other forensically determined characteristics/attributes of a user computing system. In one embodiment, the user system characteristics 160 are represented by a user system characteristics identifier that corresponds with a particular set of user system characteristics during one or more of the sessions with the tax return preparation system 111. In one embodiment, because a user computing system may use different browsers or different operating systems at different times to access the tax return preparation system 111, the user system characteristics 160 for each of the user computing systems 150 may be assigned several user system characteristics identifiers. In one embodiment, the user system characteristics identifiers are called the visitor identifiers (“VIDs”) and are shared between each of the service provider systems within the service provider computing environment 110.

In one embodiment, the service provider computing environment 110 uses the security system 112 to identify and address potential fraud activity in the tax return preparation system 111.

In one embodiment, the service provider computing environment 110 uses the security system 112 to identify and address potential fraud activity in the tax return preparation system 111 using the methods and systems disclosed in related previously filed application Ser. No. 15/220,714, attorney docket number INTU169880, entitled “METHOD AND SYSTEM FOR IDENTIFYING AND ADDRESSING POTENTIAL STOLEN IDENTIFY REFUND FRAUD ACTIVITY IN A FINANCIAL SYSTEM” filed in the name of Jonathan R. Goldman, Monica Tremont Hsu, Efraim Feinstein, and Thomas M. Pigoski II, on Jul. 27, 2016, which is incorporated herein, in its entirety, by reference.

In one embodiment, the service provider computing environment 110 uses the security system 112 to identify and address potential fraud activity in the tax return preparation system 111 using the methods and systems disclosed in related previously filed application Ser. No. 15/417,596, attorney docket number INTU1710231, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT” filed in the name of Kyle McEachern, Monica Tremont Hsu, and Brent Rambo on Jan. 27, 2017 which is incorporated herein, in its entirety, by reference.

In one embodiment, the service provider computing environment 110 uses the security system 112 to identify and address potential fraud activity in the tax return preparation system 111 using the methods and systems disclosed in related previously filed application Ser. No. 15/440,252, attorney docket number INTU1710232, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT AND TAX RETURN HISTORY” filed in the name of Kyle McEachern, Monica Tremont Hsu, and Brent Rambo on Feb. 23, 2017, which is incorporated herein, in its entirety, by reference.

In one embodiment, the service provider computing environment 110 uses the security system 112 to identify and address potential fraud activity in the tax return preparation system 111 using the methods and systems disclosed in related previously filed application Ser. No. 15/478,511, attorney docket number INTU1710233, entitled “METHOD AND SYSTEM FOR IDENTIFYING POTENTIAL FRAUD ACTIVITY IN A TAX RETURN PREPARATION SYSTEM, AT LEAST PARTIALLY BASED ON DATA ENTRY CHARACTERISTICS OF TAX RETURN CONTENT” filed in the name of Kyle McEachern and Brent Rambo on Apr. 4, 2017, which is incorporated herein, in its entirety, by reference.

In one embodiment, the security system 112 uses an analytics module 122 to determine a user potential fraud risk score 123 for the tax return 117. In one embodiment, the user potential fraud risk score 123 represents a likelihood of potential stolen identity refund fraud or fraud activity for one or more risk categories 124 associated with the tax return 117.

In one embodiment, the security system 112 uses an analytics module 122 to determine a user potential fraud risk score 123 for the tax return 117 using the methods and systems disclosed in previously filed related application Ser. No. 15/220,714, attorney docket number INTU169880, entitled “METHOD AND SYSTEM FOR IDENTIFYING AND ADDRESSING POTENTIAL STOLEN IDENTIFY REFUND FRAUD ACTIVITY IN A FINANCIAL SYSTEM” filed in the name of Jonathan R. Goldman, Monica Tremont Hsu, Efraim Feinstein, and Thomas M. Pigoski II, on Jul. 27, 2016, which is incorporated herein, in its entirety, by reference

In one embodiment, the security system 112 uses an analytics module 122 to determine a user potential fraud risk score 123 for the tax return 117 using the methods and systems disclosed in related previously filed application Ser. No. 15/417,596, attorney docket number INTU1710231, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT” filed in the name of Kyle McEachern, Monica Tremont Hsu, and Brent Rambo on Jan. 27, 2017 which is incorporated herein, in its entirety, by reference.

In one embodiment, the security system 112 uses an analytics module 122 to determine a user potential fraud risk score 123 for the tax return 117 using the methods and systems disclosed in related previously filed application Ser. No. 15/440,252, attorney docket number INTU1710232, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT AND TAX RETURN HISTORY” filed in the name of Kyle McEachern, Monica Tremont Hsu, and Brent Rambo on Feb. 23, 2017, which is incorporated herein, in its entirety, by reference

In one embodiment, the security system 112 uses an analytics module 122 to determine a user potential fraud risk score 123 for the tax return 117 using the methods and systems disclosed in related previously filed application Ser. No. 15/478,511, attorney docket number INTU1710233, entitled “METHOD AND SYSTEM FOR IDENTIFYING POTENTIAL FRAUD ACTIVITY IN A TAX RETURN PREPARATION SYSTEM, AT LEAST PARTIALLY BASED ON DATA ENTRY CHARACTERISTICS OF TAX RETURN CONTENT” filed in the name of Kyle McEachern and Brent Rambo on Apr. 4, 2017, which is incorporated herein, in its entirety, by reference.

In one embodiment, the analytics module 122 transforms one or more of the tax return content 158 for the tax return 117, the tax return content 158 for one or more prior tax returns 134, and the system access information 121 into the user potential fraud risk score 123. In one embodiment, the analytics module 122 applies one or more of the tax return content 158 for the tax return 117, the tax return content 158 for one or more prior tax returns 134, and the system access information 121 to the analytics model 125 in order to generate the user potential fraud risk score 123. In one embodiment, the analytics model 125 transforms input data into the user potential fraud risk score 123, which represents one or more user potential fraud risk scores for one or more risk categories 124 for the tax return 117. In one embodiment, if the analytics model 125 includes multiple analytics models (not shown), each of the analytics models of the analytics model 125 generates a user potential fraud risk score 123 that is associated with a single one of the risk categories 124, and multiple user potential fraud risk scores are combined to determine the user potential fraud risk score 123. In one embodiment, the risk categories 124 include, but are not limited to, change in destination bank account for tax refund, email address, claiming disability, deceased status, type of filing (e.g., 1040A, 1040EZ, etc.), number of dependents, refund amount, percentage of withholdings, total sum of wages claimed, user system characteristics, IP address, user account, occupation (some occupations are used more often by fraudsters), occupations included in tax returns filed from a particular device, measurements of how fake an amount is in a tax filing, phone numbers, the number of states claimed in the tax return, the complexity of a tax return, the number of dependents, the age of dependents, age of the tax payer, the age of a spouse the tax payer, and special fields within a tax return (e.g., whether it tax filer has special needs), according to various embodiments.

In one embodiment, the analytics model 125 is trained to detect variances in the new tax return, as compared to one or more prior tax returns, associated with a tax filer identifier.

In one embodiment, the analytics model 125 includes a tax return content model 139 and a system access information model 140 that are used in combination to determine the user potential fraud risk score 123. In one embodiment, the tax return content model 139 is a first analytics model and the system access information model 140 is a second analytics model. In one embodiment, the analytics model 125 includes multiple sub-models that are analytics models that work together to generate the user potential fraud risk score 123 based, at least partially, on the tax return content 158 and the system access information 121. In one embodiment, the tax return content model 139 generates a partial user potential fraud risk score 123 that is based on the tax return content 158 (e.g., the user characteristics 116 and the financial information 120). In one embodiment, the system access information model 140 generates a partial user potential fraud risk score 123 that is based on the system access information 121. In one embodiment, the two partial user potential fraud risk scores are one or more of combined, processed, and weighted to generate the user potential fraud risk score 123. In one embodiment, if the security system 112 only applies tax return content 158 (of a new or prior tax return) to the analytics model 125, the user potential fraud risk score 123 represents a likelihood of potential stolen identity refund fraud or fraud activity that is solely based on the tax return content 158. In one embodiment, if the security system only applies system access information 121 to the analytics model 125, the user potential fraud risk score 123 represents a likelihood of potential stolen identity refund fraud or fraud activity that is solely based on the system access information 121. In one embodiment, the security system 112 is configured to apply one or more available portions of the tax return content 158 and one or more available portions of the system access information 121 to the analytics model 125, which generates the user potential fraud risk score 123 for the tax return 117 that is representative of the one or more available portions of information that is received. Thus, in one embodiment, the user potential fraud risk score 123 is determined based on whole or partial tax return content 158 and whole or partial system access information 121 for the tax return 117.

In one embodiment, the analytics model 125 is trained using information from the tax return preparation system 111 that has been identified or reported as being linked to some type of fraudulent activity. In one embodiment, customer service personnel or other representatives of the service provider receive complaints from a user when the user accounts for the tax return preparation system 111 do not work as expected or anticipated (e.g., a tax return has been filed from a user's account without their knowledge). In one embodiment, when customer service personnel look into the complaints, they occasionally identify user accounts that have been created under another person's or other entity's name or other tax filer identifier, without the owner's knowledge. By obtaining identity information of a person or entity, a fraudster may be able to create fraudulent user accounts and create or file tax returns with stolen identity information without the permission of the owner of the identity information. In one embodiment, when an owner of the identity information creates or uses a legitimate user account to prepare or file a tax return, the owner of the identity information may receive notification that a tax return has already been prepared or filed for their tax filer identifier. In one embodiment, a complaint about such a situation is identified or flagged for potential or actual stolen identity refund fraud activity. In one embodiment, one or more analytics model building techniques is applied to the fraudulent data in the tax return content 158 and the system access information 121 to generate the analytics model 125 for one or more of the risk categories 124. In one embodiment, the analytics model 125 is trained with a training data set that includes or consists of the fraudulent tax returns with a tax filer identifier associated with one or more other prior tax returns 138, which is a subset of the tax return content 158. In one embodiment, the analytics model 125 is trained using one or more of a variety of machine learning techniques including, but not limited to, regression, logistic regression, decision trees, artificial neural networks, support vector machines, linear regression, nearest neighbor methods, distance based methods, naive Bayes, linear discriminant analysis, k-nearest neighbor algorithm, or another mathematical, statistical, logical, or relational algorithm to determine correlations or other relationships between the likelihood of potential stolen identity refund fraud activity and one or more of the tax return content 158 of new tax returns 133, the tax return content 158 of one or more prior tax returns 134, and the system access information 121.

As noted above, the analytics model 125 of analytics module 122 generates the user potential fraud risk score 123. In one embodiment, the user potential fraud risk score 123 is processed to determine if the user potential fraud risk score 123 for a particular new tax return is indicative of fraudulent activity.

In one embodiment, if the security system 112 determines that the user potential fraud risk score 123 for a particular new tax return is indicative of fraudulent activity, e.g., if the user potential fraud risk score exceeds a threshold risk score 123T, the security system 112 uses identity verification challenge module 126 to generate identity verification challenge data 127.

In one embodiment, identity verification challenge data 127 represents one or more identity verification challenges to be provided to the users 152 through the tax return preparation system 111. In one embodiment, the one or more identity verification challenges require correct identity verification challenge response data 128 from the users 152 representing correct responses to the identity verification challenges of identity verification challenge data 127, as determined by identity verification challenge response data analysis module 129.

In various embodiments, the identity verification challenges of identity verification challenge data 127 include, but are not limited to, one or more of: requests to identify or submit historical or current residences occupied by the legitimate account holder/user; requests to identify or submit one or more historical or current loans or credit accounts associated with the legitimate account holder/user; requests to identify or submit full or partial names of relatives associated with the legitimate account holder/user; requests to identify or submit recent financial activity conducted by the legitimate account holder/user; requests to identify or submit phone numbers or social media account related information associated with the legitimate account holder/user; requests to identify or submit full or partial names of relatives associated with the legitimate account holder/user; requests to identify or submit current or historical automobile, teacher, pet, friend, or nickname information associated with the legitimate account holder/user; any Multi-Factor Authentication (MFA) challenge such as, but not limited to, text message or phone call verification; and/or any other identity verification challenge, as discussed herein, and/or as known in the art at the time of filing, and/or as developed/made available after the time of filing.

In various embodiments, the correct responses to the identity verification challenges of identity verification challenges of identity verification challenge data 127, i.e., the correct identity verification challenge response data 128, is obtained by identity verification challenge response data analysis module 129 prior to the identity verification challenge data 127 being generated and issued.

In various embodiments, the correct responses to the identity verification challenges of identity verification challenges of identity verification challenge data 127, i.e., the correct identity verification challenge response data 128, is obtained by identity verification challenge response data analysis module 129 from the legitimate user account holder prior to the identity verification challenge data being generated and issued from the legitimate user/account holder.

In various embodiments, the correct responses to the identity verification challenges of identity verification challenges of identity verification challenge data 127, i.e., the correct identity verification challenge response data 128, is obtained by identity verification challenge response data analysis module 129 from analysis of historical tax return data associated with the legitimate user/account holder prior to the identity verification challenge data being generated and issued.

In various embodiments, the correct responses to the identity verification challenges of identity verification challenges of identity verification challenge data 127, i.e., the correct identity verification challenge response data 128, is obtained by identity verification challenge response data analysis module 129 from any source of correct identity verification challenge response data as discussed herein, and/or as known in the art at the time of filing, and/or as developed/made available after the time of filing.

In one embodiment, security system 112 is used to provide the user identity verification challenge data 127 to the users 152 through the tax return preparation system 111.

In one embodiment, security system 112 is used to delay submission of the user tax return 117 until identity verification challenge response data 128 is received by security system 112 from the users 152 and identity verification challenge response data analysis module 129 determines identity verification challenge response data 128 represents correct identity verification challenge response data.

In one embodiment, only once identity verification challenge response data 128 is received by security system 112 from the users 152 and identity verification challenge response data analysis module 129 determines identity verification challenge response data 128 represents correct identity verification challenge response data is the user tax return 117 submitted.

The service provider computing environment 110 includes memory 105 and processors 106 for storing and executing data representing the tax return preparation system 111 and data representing the security system 112.

Although the features and functionality of the production environment 100 are illustrated or described in terms of individual or modularized components, engines, modules, models, databases/data stores, and systems, one or more of the functions of one or more of the components, engines, modules, models, databases/data stores, or systems are functionally combinable with one or more other described or illustrated components, engines, modules, models, databases/data stores, and systems, according to various embodiments. Each of the described engines, modules, models, databases/data stores, characteristics, user experiences, content, and systems are data that can be stored in memory 105 and executed by one or more of the processors 106, according to various embodiments.

In addition, although a specific illustrative production environment 100 is shown in FIG. 1, and is discussed above, all, or any portion, of the production environments, and discussions, in related previously filed application Ser. No. 15/220,714, attorney docket number INTU169880, entitled “METHOD AND SYSTEM FOR IDENTIFYING AND ADDRESSING POTENTIAL STOLEN IDENTIFY REFUND FRAUD ACTIVITY IN A FINANCIAL SYSTEM” filed in the name of Jonathan R. Goldman, Monica Tremont Hsu, Efraim Feinstein, and Thomas M. Pigoski II, on Jul. 27, 2016, which is incorporated herein, in its entirety, by reference, and/or related previously filed application Ser. No. 15/417,596, attorney docket number INTU1710231, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT” filed in the name of Kyle McEachern, Monica Tremont Hsu, and Brent Rambo on Jan. 27, 2017 which is incorporated herein, in its entirety, by reference, and/or related previously filed application Ser. No. 15/440,252, attorney docket number INTU1710232, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT AND TAX RETURN HISTORY” filed in the name of Kyle McEachern, Monica Tremont Hsu, and Brent Rambo on Feb. 23, 2017, which is incorporated herein, in its entirety, by reference, and/or related previously filed application Ser. No. 15/478,511, attorney docket number INTU1710233, entitled “METHOD AND SYSTEM FOR IDENTIFYING POTENTIAL FRAUD ACTIVITY IN A TAX RETURN PREPARATION SYSTEM, AT LEAST PARTIALLY BASED ON DATA ENTRY CHARACTERISTICS OF TAX RETURN CONTENT” filed in the name of Kyle McEachern and Brent Rambo on Apr. 4, 2017, which is incorporated herein, in its entirety, by reference, are applicable and can be incorporated in the discussion above.

Consequently, using embodiments disclosed herein, analysis of tax related data is performed to identify potential fraudulent activity in a tax return preparation system before the tax return related data is submitted. Then, if potential fraud is detected, a user of the tax return preparation system is required to further prove their identity before the tax return data is submitted. As a result, using embodiments disclosed herein, potentially fraudulent activity is challenged before the tax related data is submitted and therefore before rules regarding the processing of “submitted” tax data are triggered or take effect.

Therefore, using embodiments disclosed herein, a technical solution is provided to the long standing and Internet-centric technical problem of efficiently and reliably identifying potentially fraudulent activity and then preventing the identified potentially fraudulent data from being submitted while, at the same time, complying with tax return preparation service provider rules that have been mandated by federal and state tax revenue collection agencies.

### Process

As noted above, given the exponential rise in computer data and identity theft, and significant impact of fraud perpetuated using tax return preparation systems, providers of tax return preparation systems are highly motivated to identify and/or prevent fraud perpetuated using their tax return preparation systems. However, the tax revenue collection and government agencies, such as the IRS, that are ultimately responsible for processing tax returns, and collecting taxes, have generated several rules and procedures that must be adhered to by the providers of tax return preparation systems to ensure that use of the tax return preparation systems does not interfere with, or unduly burden or slow down, the tax processing and collection process for either the tax filer or the revenue agency.

As a specific example, in order to comply with tax revenue collection and government agency regulations, some tax return preparation systems require that, once tax return data is submitted to the tax return preparation system, the tax return form/data must be submitted to the IRS within 72 hours. Therefore, even in cases where potential tax fraud is identified by a tax return preparation system provider, the potentially fraudulent tax return data is still submitted to the IRS within 72 hours. In these cases, the potential fraud must be identified, investigated, and resolved, within 72 hours. Clearly, this results in many identified potentially fraudulent tax returns being submitted to the IRS, despite known concerns regarding the legitimacy of the tax return data and/or the identity of the tax flier.

However, the situation is further complicated by the fact that the most common prior art solution for investigating identified potential tax return fraud is to generate and send one or more messages to the tax return data submitter associated with the account, or an identifier such as a Social Security number, using email, text, or phone associated with an account or Social Security number. Unfortunately, this mechanism often results in simply notifying the fraudster that they have been identified while not necessarily helping the victims of the fraud. In addition, even if these messages reach the legitimate tax filer, the messages must be read and responded to within 72 hours. Again, this results in many identified potentially fraudulent tax returns being submitted to the IRS because there simply was not enough time for a legitimate filer to check their email, open the message, contact the proper party, such as the provider of the tax return preparation system, and potentially clear up the issue, within the 72-hour limit.

In addition, current regulations imposed by tax revenue collection agencies such as the IRS, prevent providers of tax return preparation systems from making any challenge to the submitted tax return data other than simply ensuring the identity of the submitter. That is to say, currently, tax return preparation system providers are not allowed to question the validity of the submitted tax return data itself or investigate fraud issues beyond ensuring the user of the tax return preparation system is who they say they are.

As a result, providers of tax return preparation systems, tax filers, and tax revenue collection agencies, all currently face the long standing technical problem of efficiently and reliably identifying potentially fraudulent activity and then preventing the identified potentially fraudulent data from being submitted while, at the same time, complying with tax return preparation service provider rules that have been mandated by federal and state tax revenue collection agencies.

However, using the embodiments of the present disclosure, special data sources and algorithms are used to analyze tax return data in order to identify potential fraudulent activity before the tax return data is submitted in a tax return preparation system. Then, once the potential fraudulent activity is identified, one or more identity verification challenges are generated and issued through the tax return preparation system. A correct response to identity verification challenge is then required from the user associated with the potential fraudulent activity before the tax return data is submitted.

Consequently, using embodiments disclosed herein, analysis of tax related data is performed to identify potential fraudulent activity in a tax return preparation system before the tax return related data is submitted. Then, if potential fraud is detected, a user of the tax return preparation system is required to further prove their identity before the tax return data is submitted. As a result, using embodiments disclosed herein, potentially fraudulent activity is challenged before the tax related data is submitted and therefore before rules regarding the processing of “submitted” tax data are triggered or take effect.

Therefore, using embodiments disclosed herein, a technical solution is provided to the long standing technical problem of efficiently and reliably identifying potentially fraudulent activity and then preventing the identified potentially fraudulent data from being submitted, all before the fraud is committed and, at the same time, complying with tax return preparation service provider rules that have been mandated by federal and state tax revenue collection agencies.

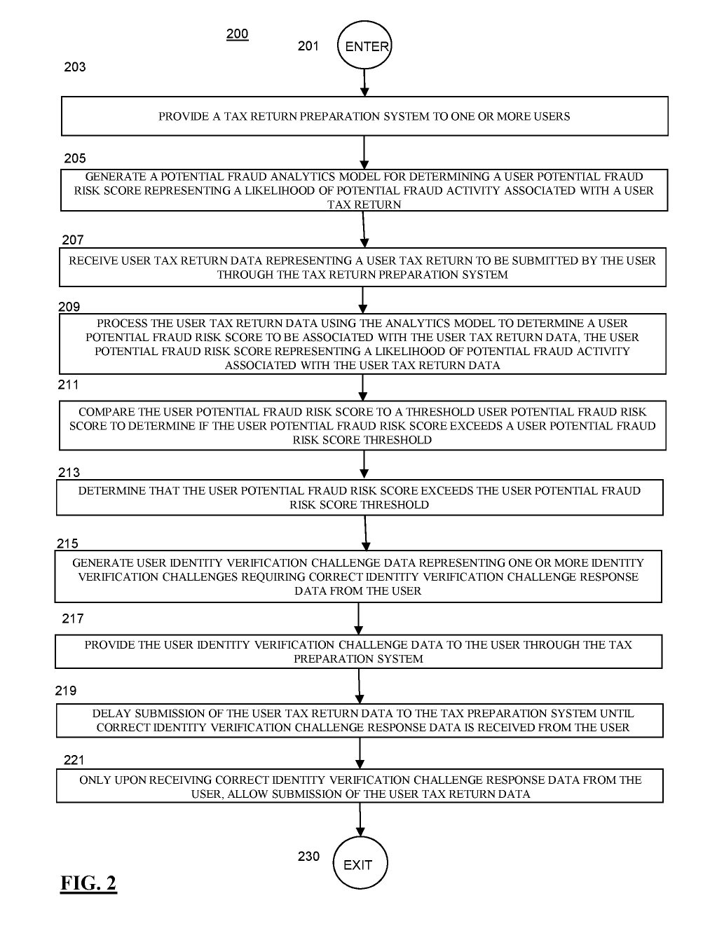

FIG. 2 illustrates an example flow diagram of a process 200 for identifying potential fraud activity in a tax return preparation system to trigger an identity verification challenge through the tax return preparation system.

In one embodiment, process 200 for identifying potential fraud activity in a tax return preparation system to trigger an identity verification challenge through the tax return preparation system begins at ENTER OPERATION 201 and process flow proceeds to PROVIDE A TAX RETURN PREPARATION SYSTEM TO ONE OR MORE USERS OPERATION 203.

In one embodiment, at PROVIDE A TAX RETURN PREPARATION SYSTEM TO ONE OR MORE USERS OPERATION 203, one or more computing systems are used to provide a tax return preparation system to one or more users of the tax return preparation system.

In one embodiment, the tax return preparation system of PROVIDE A TAX RETURN PREPARATION SYSTEM TO ONE OR MORE USERS OPERATION 203 is any tax return preparation system as discussed herein, and/or as known in the art at the time of filing, and/or as developed after the time of filing.

In one embodiment, at PROVIDE A TAX RETURN PREPARATION SYSTEM TO ONE OR MORE USERS OPERATION 203, one or more computing systems are used to obtain and store prior tax return content data associated with prior tax return data representing prior tax returns submitted by one or more users of the tax return preparation system.

In one embodiment, once one or more computing systems are used to provide a tax return preparation system to one or more users of the tax return preparation system at PROVIDE A TAX RETURN PREPARATION SYSTEM TO ONE OR MORE USERS OPERATION 203, process flow proceeds to GENERATE A POTENTIAL FRAUD ANALYTICS MODEL FOR DETERMINING A USER POTENTIAL FRAUD RISK SCORE REPRESENTING A LIKELIHOOD OF POTENTIAL FRAUD ACTIVITY ASSOCIATED WITH A USER TAX RETURN OPERATION 205.

In one embodiment, at GENERATE A POTENTIAL FRAUD ANALYTICS MODEL FOR DETERMINING A USER POTENTIAL FRAUD RISK SCORE REPRESENTING A LIKELIHOOD OF POTENTIAL FRAUD ACTIVITY ASSOCIATED WITH A USER TAX RETURN OPERATION 205, one or more computing systems are used to generate potential fraud analytics model data representing a potential fraud analytics model for determining a user potential fraud risk score to be associated with tax return content data included in tax return data representing tax returns associated with users of the tax return preparation system.

In one embodiment, the potential fraud analytics model of GENERATE A POTENTIAL FRAUD ANALYTICS MODEL FOR DETERMINING A USER POTENTIAL FRAUD RISK SCORE REPRESENTING A LIKELIHOOD OF POTENTIAL FRAUD ACTIVITY ASSOCIATED WITH A USER TAX RETURN OPERATION 205 is the potential fraud analytics model described in previously filed related application Ser. No. 15/417,596, attorney docket number INTU1710231, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT” filed in the name of Kyle McEachern, Monica Tremont Hsu, and Brent Rambo on Jan. 27, 2017 which is incorporated herein, in its entirety, by reference.

In one embodiment, the potential fraud analytics model of GENERATE A POTENTIAL FRAUD ANALYTICS MODEL FOR DETERMINING A USER POTENTIAL FRAUD RISK SCORE REPRESENTING A LIKELIHOOD OF POTENTIAL FRAUD ACTIVITY ASSOCIATED WITH A USER TAX RETURN OPERATION 205 is the potential fraud analytics model described in previously filed related application Ser. No. 15/440,252, attorney docket number INTU1710232, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT AND TAX RETURN HISTORY” filed in the name of Kyle McEachern, Monica Tremont Hsu, and Brent Rambo on Feb. 23, 2017, which is incorporated herein, in its entirety, by reference.

In one embodiment, the potential fraud analytics model of GENERATE A POTENTIAL FRAUD ANALYTICS MODEL FOR DETERMINING A USER POTENTIAL FRAUD RISK SCORE REPRESENTING A LIKELIHOOD OF POTENTIAL FRAUD ACTIVITY ASSOCIATED WITH A USER TAX RETURN OPERATION 205 is the potential fraud analytics model described previously filed related application Ser. No. 15/478,511, attorney docket number INTU1710233, entitled “METHOD AND SYSTEM FOR IDENTIFYING POTENTIAL FRAUD ACTIVITY IN A TAX RETURN PREPARATION SYSTEM, AT LEAST PARTIALLY BASED ON DATA ENTRY CHARACTERISTICS OF TAX RETURN CONTENT” filed in the name of Kyle McEachern and Brent Rambo on Apr. 4, 2017, which is incorporated herein, in its entirety, by reference.

In one embodiment, the potential fraud analytics model of GENERATE A POTENTIAL FRAUD ANALYTICS MODEL FOR DETERMINING A USER POTENTIAL FRAUD RISK SCORE REPRESENTING A LIKELIHOOD OF POTENTIAL FRAUD ACTIVITY ASSOCIATED WITH A USER TAX RETURN OPERATION 205 is any potential fraud analytics model as described herein, and/or as known in the art at the time of filing, and/or as developed/made available after the time of filing.

In one embodiment, once one or more computing systems are used to generate potential fraud analytics model data representing a potential fraud analytics model for determining a user potential fraud risk score to be associated with tax return content data included in tax return data representing tax returns associated with users of the tax return preparation system at GENERATE A POTENTIAL FRAUD ANALYTICS MODEL FOR DETERMINING A USER POTENTIAL FRAUD RISK SCORE REPRESENTING A LIKELIHOOD OF POTENTIAL FRAUD ACTIVITY ASSOCIATED WITH A USER TAX RETURN OPERATION 205, process flow proceeds to RECEIVE USER TAX RETURN DATA REPRESENTING A USER TAX RETURN TO BE SUBMITTED BY THE USER THROUGH THE TAX RETURN PREPARATION SYSTEM OPERATION 207.

In one embodiment, at RECEIVE USER TAX RETURN DATA REPRESENTING A USER TAX RETURN TO BE SUBMITTED BY THE USER THROUGH THE TAX RETURN PREPARATION SYSTEM OPERATION 207, user tax return data is received by the tax return preparation system of PROVIDE A TAX RETURN PREPARATION SYSTEM TO ONE OR MORE USERS OPERATION 203.

In one embodiment, once user tax return data is received by the tax return preparation system at RECEIVE USER TAX RETURN DATA REPRESENTING A USER TAX RETURN TO BE SUBMITTED BY THE USER THROUGH THE TAX RETURN PREPARATION SYSTEM OPERATION 207, process flow proceeds to PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209.

In one embodiment, at PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209, the user tax return data is analyzed using the potential fraud analytics model data of GENERATE A POTENTIAL FRAUD ANALYTICS MODEL FOR DETERMINING A USER POTENTIAL FRAUD RISK SCORE REPRESENTING A LIKELIHOOD OF POTENTIAL FRAUD ACTIVITY ASSOCIATED WITH A USER TAX RETURN OPERATION 205 to determine a user potential fraud risk score.

In one embodiment, at PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209, the user tax return data is analyzed using the potential fraud analytics model data of GENERATE A POTENTIAL FRAUD ANALYTICS MODEL FOR DETERMINING A USER POTENTIAL FRAUD RISK SCORE REPRESENTING A LIKELIHOOD OF POTENTIAL FRAUD ACTIVITY ASSOCIATED WITH A USER TAX RETURN OPERATION 205 to determine a user potential fraud risk score using the methods and systems described in previously filed related application Ser. No. 15/417,596, attorney docket number INTU1710231, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT” filed in the name of Kyle McEachern, Monica Tremont Hsu, and Brent Rambo on Jan. 27, 2017 which is incorporated herein, in its entirety.

Consequently, in one embodiment, at PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209, potential fraudulent activity is identified based, at least partially, on potential fraudulent activity algorithms of a potential fraud analytics model applied to tax return content. In one embodiment, the tax return content associated with a user account within a tax return preparation system is obtained and provided to the analytics model which generates a user potential fraud risk score based on the tax return content. In addition, in one embodiment, the user potential fraud risk score is based, at least partially, on system access information that represents characteristics of the device used to file a tax return. Consequently, in one embodiment, the user potential fraud risk score represents a likelihood of potential fraud activity associated with tax return content data.

In one embodiment, at PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209, the user tax return data is analyzed using the potential fraud analytics model data of GENERATE A POTENTIAL FRAUD ANALYTICS MODEL FOR DETERMINING A USER POTENTIAL FRAUD RISK SCORE REPRESENTING A LIKELIHOOD OF POTENTIAL FRAUD ACTIVITY ASSOCIATED WITH A USER TAX RETURN OPERATION 205 to determine a user potential fraud risk score using the methods and systems described in previously filed related application Ser. No. 15/440,252, attorney docket number INTU1710232, entitled “METHOD AND SYSTEM FOR IDENTIFYING POTENTIAL FRAUD ACTIVITY IN A TAX RETURN PREPARATION SYSTEM, AT LEAST PARTIALLY BASED ON TAX RETURN CONTENT AND TAX RETURN HISTORY” filed in the name of Kyle McEachern, Monica Tremont Hsu, and Brent Rambo on Feb. 23, 2017, which is incorporated herein, in its entirety.

Consequently, in one embodiment, at PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209, potential fraudulent activity is identified based, at least partially, on potential fraudulent activity algorithms of a potential fraud analytics model applied to new tax return content and tax return history. In one embodiment, new tax return content of a new tax return associated with a tax filer identifier (e.g., Social Security Number) is compared to prior tax return content of one or more prior tax returns for the tax filer identifier. In one embodiment, a user potential fraud risk score is then generated based on the comparison. In one embodiment, the user potential fraud risk score is determined based, at least partially, on applying the new tax return content of the new tax return and the prior tax return content of one or more prior tax returns to an analytics model. In addition, in one embodiment, the user potential fraud risk score is determined based, at least partially, on applying system access information to an analytics model. In one embodiment, the system access information represents characteristics of the device used to file the new tax return. Consequently, in one embodiment, the user potential fraud risk score represents a likelihood of potential fraud activity associated with new user tax returns associated with the tax filer identifier that is determined, based, at least partially, on tax return history for the tax filer identifier.

In one embodiment, at PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209, the user tax return data is analyzed using the potential fraud analytics model data of GENERATE A POTENTIAL FRAUD ANALYTICS MODEL FOR DETERMINING A USER POTENTIAL FRAUD RISK SCORE REPRESENTING A LIKELIHOOD OF POTENTIAL FRAUD ACTIVITY ASSOCIATED WITH A USER TAX RETURN OPERATION 205 to determine a user potential fraud risk score using the methods and systems described in previously filed related application Ser. No. 15/478,511, attorney docket number INTU1710233, entitled “METHOD AND SYSTEM FOR IDENTIFYING POTENTIAL FRAUD ACTIVITY IN A TAX RETURN PREPARATION SYSTEM, AT LEAST PARTIALLY BASED ON DATA ENTRY CHARACTERISTICS OF TAX RETURN CONTENT” filed in the name of Kyle McEachern and Brent Rambo on Apr. 4, 2017, which is incorporated herein, in its entirety.

Consequently, in one embodiment, at PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209, the potential fraudulent activity is identified based, at least partially, on potential fraudulent activity algorithms of a potential fraud analytics model applied to data entry characteristics of tax return content provided to the tax return preparation system by users of the tax return preparation system. In one embodiment, new tax return content of a new tax return associated with a tax filer identifier (e.g., Social Security Number) is compared to the prior data entry characteristics of prior tax return content of one or more prior tax returns entered into the tax return preparation system. In one embodiment, a user potential fraud risk score is determined based on the comparison. In one embodiment, the user potential fraud risk score is determined based on applying the new data entry characteristics of new tax return content of a new tax return to an analytics model. In one embodiment, the user potential fraud risk score is determined based, at least partially, on applying system access information to an analytics model. In one embodiment, the system access information represents characteristics of the device used to file the new tax return. Consequently, in one embodiment, the user potential fraud risk score represents a likelihood of potential fraud activity associated with the tax return for the tax filer identifier that is determined, based, at least partially, on the user data entry characteristics for the tax return.

In one embodiment, at PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209, the user tax return data is analyzed using the potential fraud analytics model data of GENERATE A POTENTIAL FRAUD ANALYTICS MODEL FOR DETERMINING A USER POTENTIAL FRAUD RISK SCORE REPRESENTING A LIKELIHOOD OF POTENTIAL FRAUD ACTIVITY ASSOCIATED WITH A USER TAX RETURN OPERATION 205 to determine a user potential fraud risk score using any method, means, system, or mechanism for determining a user potential fraud risk score, as discussed herein, and/or as known in the art at the time of filing, and/or as developed after the time of filing, and represents a likelihood of potential fraud activity associated with the tax return for the tax filer identifier based, at least partially, on any analysis factors desired, as discussed herein, and/or as known in the art at the time of filing, and/or as developed after the time of filing.

In one embodiment, at PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209, once a user potential fraud risk score is determined, one or more computing systems are used to generate user potential fraud risk score data representing the determined user potential fraud risk score.

In one embodiment, once the user tax return data is analyzed using the potential fraud analytics model to determine a user potential fraud risk score, and user potential fraud risk score data representing the determined user potential fraud risk score is generated, at PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209, process flow proceeds to COMPARE THE USER POTENTIAL FRAUD RISK SCORE TO A THRESHOLD USER POTENTIAL FRAUD RISK SCORE TO DETERMINE IF THE USER POTENTIAL FRAUD RISK SCORE EXCEEDS A USER POTENTIAL FRAUD RISK SCORE THRESHOLD OPERATION 211.

In one embodiment, at COMPARE THE USER POTENTIAL FRAUD RISK SCORE TO A THRESHOLD USER POTENTIAL FRAUD RISK SCORE TO DETERMINE IF THE USER POTENTIAL FRAUD RISK SCORE EXCEEDS A USER POTENTIAL FRAUD RISK SCORE THRESHOLD OPERATION 211, one or more computing systems are used to compare the user potential fraud risk score represented by the user potential fraud risk score data of PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209 to a defined threshold user potential fraud risk score represented by user potential fraud risk score threshold data to determine if the user potential fraud risk score exceeds a user potential fraud risk score threshold.

In one embodiment, once one or more computing systems are used to compare the user potential fraud risk score represented by the user potential fraud risk score data to a defined threshold user potential fraud risk score represented by user potential fraud risk score threshold data to determine if the user potential fraud risk score exceeds a user potential fraud risk score threshold at COMPARE THE USER POTENTIAL FRAUD RISK SCORE TO A THRESHOLD USER POTENTIAL FRAUD RISK SCORE TO DETERMINE IF THE USER POTENTIAL FRAUD RISK SCORE EXCEEDS A USER POTENTIAL FRAUD RISK SCORE THRESHOLD OPERATION 211, process flow proceeds to DETERMINE THAT THE USER POTENTIAL FRAUD RISK SCORE EXCEEDS THE USER POTENTIAL FRAUD RISK SCORE THRESHOLD OPERATION 213.

In one embodiment, at DETERMINE THAT THE USER POTENTIAL FRAUD RISK SCORE EXCEEDS THE USER POTENTIAL FRAUD RISK SCORE THRESHOLD OPERATION 213 as a result of the analysis at COMPARE THE USER POTENTIAL FRAUD RISK SCORE TO A THRESHOLD USER POTENTIAL FRAUD RISK SCORE TO DETERMINE IF THE USER POTENTIAL FRAUD RISK SCORE EXCEEDS A USER POTENTIAL FRAUD RISK SCORE THRESHOLD OPERATION 211, a determination is made that the user potential fraud risk score of PROCESS THE USER TAX RETURN DATA USING THE ANALYTICS MODEL TO DETERMINE A USER POTENTIAL FRAUD RISK SCORE TO BE ASSOCIATED WITH THE USER TAX RETURN DATA, THE USER POTENTIAL FRAUD RISK SCORE REPRESENTING A LIKELIHOOD OF POTENTIAL FRAUD ACTIVITY ASSOCIATED WITH THE USER TAX RETURN DATA OPERATION 209 exceeds the user potential fraud risk score threshold.

In one embodiment, once a determination is made that the user potential fraud risk score exceeds the user potential fraud risk score threshold at DETERMINE THAT THE USER POTENTIAL FRAUD RISK SCORE EXCEEDS THE USER POTENTIAL FRAUD RISK SCORE THRESHOLD OPERATION 213, process flow proceeds to GENERATE USER IDENTITY VERIFICATION CHALLENGE DATA REPRESENTING ONE OR MORE IDENTITY VERIFICATION CHALLENGES REQUIRING CORRECT IDENTITY VERIFICATION CHALLENGE RESPONSE DATA FROM THE USER OPERATION 215.

In one embodiment, at GENERATE USER IDENTITY VERIFICATION CHALLENGE DATA REPRESENTING ONE OR MORE IDENTITY VERIFICATION CHALLENGES REQUIRING CORRECT IDENTITY VERIFICATION CHALLENGE RESPONSE DATA FROM THE USER OPERATION 215, one or more computing systems are used to generate user identity verification challenge data representing one or more identity verification challenges to be provided to the user through the tax return preparation system of PROVIDE A TAX RETURN PREPARATION SYSTEM TO ONE OR MORE USERS OPERATION 203.

In one embodiment, the one or more identity verification challenges of GENERATE USER IDENTITY VERIFICATION CHALLENGE DATA REPRESENTING ONE OR MORE IDENTITY VERIFICATION CHALLENGES REQUIRING CORRECT IDENTITY VERIFICATION CHALLENGE RESPONSE DATA FROM THE USER OPERATION 215 require correct identity verification challenge response data from the user representing correct responses to the identity verification challenges.

In various embodiments, the identity verification challenges of GENERATE USER IDENTITY VERIFICATION CHALLENGE DATA REPRESENTING ONE OR MORE IDENTITY VERIFICATION CHALLENGES REQUIRING CORRECT IDENTITY VERIFICATION CHALLENGE RESPONSE DATA FROM THE USER OPERATION 215 include, but are not limited to, one or more of: requests to identify or submit historical or current residences occupied by the legitimate account holder/user; requests to identify or submit one or more historical or current loans or credit accounts associated with the legitimate account holder/user; requests to identify or submit full or partial names of relatives associated with the legitimate account holder/user; requests to identify or submit recent financial activity conducted by the legitimate account holder/user; requests to identify or submit phone numbers or social media account related information associated with the legitimate account holder/user; requests to identify or submit full or partial names of relatives associated with the legitimate account holder/user; requests to identify or submit current or historical automobile, teacher, pet, friend, or nickname information associated with the legitimate account holder/user; any Multi-Factor Authentication (MFA) challenge such as, but not limited to, text message or phone call verification; and/or any other identity verification challenge, as discussed herein, and/or as known in the art at the time of filing, and/or as developed/made available after the time of filing.

In various embodiments, the correct responses to the identity verification challenges, i.e., the correct identity verification challenge response data, of GENERATE USER IDENTITY VERIFICATION CHALLENGE DATA REPRESENTING ONE OR MORE IDENTITY VERIFICATION CHALLENGES REQUIRING CORRECT IDENTITY VERIFICATION CHALLENGE RESPONSE DATA FROM THE USER OPERATION 215 is obtained prior to the identity verification challenge data being generated and issued at GENERATE USER IDENTITY VERIFICATION CHALLENGE DATA REPRESENTING ONE OR MORE IDENTITY VERIFICATION CHALLENGES REQUIRING CORRECT IDENTITY VERIFICATION CHALLENGE RESPONSE DATA FROM THE USER OPERATION 215.

In various embodiments, the correct responses to the identity verification challenges, i.e., the correct identity verification challenge response data, of GENERATE USER IDENTITY VERIFICATION CHALLENGE DATA REPRESENTING ONE OR MORE IDENTITY VERIFICATION CHALLENGES REQUIRING CORRECT IDENTITY VERIFICATION CHALLENGE RESPONSE DATA FROM THE USER OPERATION 215 is obtained from the legitimate user account holder prior to the identity verification challenge data being generated and issued from the legitimate user/account holder.

In various embodiments, the correct responses to the identity verification challenges, i.e., the correct identity verification challenge response data, of GENERATE USER IDENTITY VERIFICATION CHALLENGE DATA REPRESENTING ONE OR MORE IDENTITY VERIFICATION CHALLENGES REQUIRING CORRECT IDENTITY VERIFICATION CHALLENGE RESPONSE DATA FROM THE USER OPERATION 215 is obtained from analysis of historical tax return data associated with the legitimate user/account holder prior to the identity verification challenge data being generated and issued.

In various embodiments, the correct responses to the identity verification challenges, i.e., the correct identity verification challenge response data, of GENERATE USER IDENTITY VERIFICATION CHALLENGE DATA REPRESENTING ONE OR MORE IDENTITY VERIFICATION CHALLENGES REQUIRING CORRECT IDENTITY VERIFICATION CHALLENGE RESPONSE DATA FROM THE USER OPERATION 215 is obtained from any source of correct identity verification challenge response data as discussed herein, and/or as known in the art at the time of filing, and/or as developed/made available after the time of filing.

In one embodiment, once one or more computing systems are used to generate user identity verification challenge data representing one or more identity verification challenges to be provided to the user through the tax return preparation system at GENERATE USER IDENTITY VERIFICATION CHALLENGE DATA REPRESENTING ONE OR MORE IDENTITY VERIFICATION CHALLENGES REQUIRING CORRECT IDENTITY VERIFICATION CHALLENGE RESPONSE DATA FROM THE USER OPERATION 215, process flow proceeds to PROVIDE THE USER IDENTITY VERIFICATION CHALLENGE DATA TO THE USER THROUGH THE TAX RETURN PREPARATION SYSTEM OPERATION 217.

In one embodiment, at PROVIDE THE USER IDENTITY VERIFICATION CHALLENGE DATA TO THE USER THROUGH THE TAX RETURN PREPARATION SYSTEM OPERATION 217, one or more computing systems are used to provide the user identity verification challenge data to the user through the tax return preparation system of PROVIDE A TAX RETURN PREPARATION SYSTEM TO ONE OR MORE USERS OPERATION 203.

In one embodiment, once one or more computing systems are used to provide the user identity verification challenge data to the user through the tax return preparation system at PROVIDE THE USER IDENTITY VERIFICATION CHALLENGE DATA TO THE USER THROUGH THE TAX RETURN PREPARATION SYSTEM OPERATION 217, process flow proceeds to DELAY SUBMISSION OF THE USER TAX RETURN DATA TO THE TAX RETURN PREPARATION SYSTEM UNTIL CORRECT IDENTITY VERIFICATION CHALLENGE RESPONSE DATA IS RECEIVED FROM THE USER OPERATION 219.

In one embodiment, at DELAY SUBMISSION OF THE USER TAX RETURN DATA TO THE TAX RETURN PREPARATION SYSTEM UNTIL CORRECT IDENTITY VERIFICATION CHALLENGE RESPONSE DATA IS RECEIVED FROM THE USER OPERATION 219, one or more computing systems are used to delay submission of the user tax return associated with the user tax return data of RECEIVE USER TAX RETURN DATA REPRESENTING A USER TAX RETURN TO BE SUBMITTED BY THE USER THROUGH THE TAX RETURN PREPARATION SYSTEM OPERATION 207 until correct identity verification challenge response data is received from the user representing correct responses to the identity verification challenges of PROVIDE THE USER IDENTITY VERIFICATION CHALLENGE DATA TO THE USER THROUGH THE TAX RETURN PREPARATION SYSTEM OPERATION 217.

In one embodiment, once one or more computing systems are used to delay submission of the user tax return associated with the user tax return data until correct identity verification challenge response data is received from the user representing correct responses to the identity verification challenges at DELAY SUBMISSION OF THE USER TAX RETURN DATA TO THE TAX RETURN PREPARATION SYSTEM UNTIL CORRECT IDENTITY VERIFICATION CHALLENGE RESPONSE DATA IS RECEIVED FROM THE USER OPERATION 219, process flow proceeds to ONLY UPON RECEIVING CORRECT IDENTITY VERIFICATION CHALLENGE RESPONSE DATA FROM THE USER, ALLOW SUBMISSION OF THE USER TAX RETURN DATA OPERATION 221.

In one embodiment, at ONLY UPON RECEIVING CORRECT IDENTITY VERIFICATION CHALLENGE RESPONSE DATA FROM THE USER, ALLOW SUBMISSION OF THE USER TAX RETURN DATA OPERATION 221, only upon receiving correct identity verification challenge response data from the user at DELAY SUBMISSION OF THE USER TAX RETURN DATA TO THE TAX RETURN PREPARATION SYSTEM UNTIL CORRECT IDENTITY VERIFICATION CHALLENGE RESPONSE DATA IS RECEIVED FROM THE USER OPERATION 219 representing correct responses to the identity verification challenges of PROVIDE THE USER IDENTITY VERIFICATION CHALLENGE DATA TO THE USER THROUGH THE TAX RETURN PREPARATION SYSTEM OPERATION 217, are one or more computing systems used to allow submission of the user tax return data representing the user tax return associated with the user tax return data of RECEIVE USER TAX RETURN DATA REPRESENTING A USER TAX RETURN TO BE SUBMITTED BY THE USER THROUGH THE TAX RETURN PREPARATION SYSTEM OPERATION 207.

In one embodiment, once only upon receiving correct identity verification challenge response data from the user at DELAY SUBMISSION OF THE USER TAX RETURN DATA TO THE TAX RETURN PREPARATION SYSTEM UNTIL CORRECT IDENTITY VERIFICATION CHALLENGE RESPONSE DATA IS RECEIVED FROM THE USER OPERATION 219 representing correct responses to the identity verification challenges of PROVIDE THE USER IDENTITY VERIFICATION CHALLENGE DATA TO THE USER THROUGH THE TAX RETURN PREPARATION SYSTEM OPERATION 217, are one or more computing systems used to allow submission of the user tax return data representing the user tax return associated with the user tax return data of RECEIVE USER TAX RETURN DATA REPRESENTING A USER TAX RETURN TO BE SUBMITTED BY THE USER THROUGH THE TAX RETURN PREPARATION SYSTEM OPERATION 207 at ONLY UPON RECEIVING CORRECT IDENTITY VERIFICATION CHALLENGE RESPONSE DATA FROM THE USER, ALLOW SUBMISSION OF THE USER TAX RETURN DATA OPERATION 221, process flow proceeds to EXIT OPERATION 230.

In one embodiment, at EXIT OPERATION 230, process 200 for identifying potential fraud activity in a tax return preparation system to trigger an identity verification challenge through the tax return preparation system is exited to await new data.

As noted above, the specific illustrative examples discussed above are but illustrative examples of implementations of embodiments of the method or process for identifying potential fraud activity in a tax return preparation system to trigger an identity verification challenge through the tax return preparation system. Those of skill in the art will readily recognize that other implementations and embodiments are possible. Therefore, the discussion above should not be construed as a limitation on the claims provided below.

The present disclosure addresses some of the short comings of prior art methods and systems by using special data sources and algorithms to analyze tax return data in order to identify potential fraudulent activity before the tax return data is submitted in a tax return preparation system. Then, once the potential fraudulent activity is identified, one or more identity verification challenges are generated and issued through the tax return preparation system. A correct response to identity verification challenge is then required from the user associated with the potential fraudulent activity before the tax return data is submitted.

Consequently, using embodiments disclosed herein, analysis of tax related data is performed to identify potential fraudulent activity in a tax return preparation system before the tax return related data is submitted. Then, if potential fraud is detected, a user of the tax return preparation system is required to further prove their identity before the tax return data is submitted. As a result, using embodiments disclosed herein, potentially fraudulent activity is challenged before the tax related data is submitted and therefore before rules regarding the processing of “submitted” tax data are triggered or take effect.

Therefore, using embodiments disclosed herein, a technical solution is provided to the long standing technical problem of efficiently and reliably identifying potentially fraudulent activity and then preventing the identified potentially fraudulent data from being submitted while, at the same time, complying with tax return preparation service provider rules that have been mandated by federal and state tax revenue collection agencies.

In addition, the disclosed embodiments do not represent an abstract idea for at least a few reasons. First, identifying potential fraud activity in a tax return preparation system to trigger an identity verification challenge is not an abstract idea because it is not merely an idea itself (e.g., cannot be performed mentally or using pen and paper), and requires the use of special data sources and data processing algorithms. Indeed, some of the disclosed embodiments include applying data representing tax return content to analytics models to determine data representing user potential fraud risk scores, which cannot be performed mentally.

Second, identifying potential fraud activity in a tax return preparation system to trigger an identity verification challenge is not an abstract idea because it is not a fundamental economic practice (e.g., is not merely creating a contractual relationship, hedging, mitigating a settlement risk, etc.).

Third, identifying potential fraud activity in a tax return preparation system to trigger an identity verification challenge is not an abstract idea because it is not a method of organizing human activity (e.g., managing a game of bingo).

Fourth, although, in one embodiment, mathematics may be used to generate an analytics model, identifying potential fraud activity in a tax return preparation system to trigger an identity verification challenge is not simply a mathematical relationship/formula but is instead a technique for transforming data representing tax return content and system access information into data representing a user potential fraud risk score which quantifies the likelihood that a tax return is being fraudulently prepared or submitted.

In addition, generating identity verification challenge data in response to a determined threshold level of fraud risk, delivering the identity verification challenge data to a user of a tax return preparation system, receiving identity verification response data from the user, and then analyzing the identity verification response data, all through the tax return preparation system is neither merely an idea itself, a fundamental economic practice, a method of organizing human activity, nor simply a mathematical relationship/formula.

Further, identifying potential fraud activity in a tax return preparation system to trigger an identity verification challenge allows for significant improvement to the technical fields of information security, fraud detection, and tax return preparation systems. In addition, the present disclosure adds significantly to the field of tax return preparation systems by reducing the risk of victimization in tax return filings and by increasing tax return preparation system users' trust in the tax return preparation system. This reduces the likelihood of users seeking other less efficient techniques (e.g., via a spreadsheet, or by downloading individual tax return data) for preparing and filing their tax returns.

As a result, embodiments of the present disclosure allow for reduced use of processor cycles, processor power, communications bandwidth, memory, and power consumption, by reducing the number of users who utilize inefficient tax return preparation techniques, by efficiently and effectively reducing the amount of fraudulent data processed, and by reducing the number of instances of false positives for fraudulent activity. Consequently, computing and communication systems implementing or providing the embodiments of the present disclosure are transformed into more operationally efficient devices and systems.

In addition to improving overall computing performance, identifying potential fraud activity in a tax return preparation system to trigger an identity verification challenge helps maintain or build trust and therefore loyalty in the tax return preparation system, which results in repeat customers, efficient delivery of tax return preparation services, and reduced abandonment of use of the tax return preparation system.

In the discussion above, certain aspects of one embodiment include process steps or operations or instructions described herein for illustrative purposes in a particular order or grouping. However, the particular order or grouping shown and discussed herein are illustrative only and not limiting. Those of skill in the art will recognize that other orders or grouping of the process steps or operations or instructions are possible and, in some embodiments, one or more of the process steps or operations or instructions discussed above can be combined or deleted. In addition, portions of one or more of the process steps or operations or instructions can be re-grouped as portions of one or more other of the process steps or operations or instructions discussed herein. Consequently, the particular order or grouping of the process steps or operations or instructions discussed herein do not limit the scope of the invention as claimed below.

As discussed in more detail above, using the above embodiments, with little or no modification or input, there is considerable flexibility, adaptability, and opportunity for customization to meet the specific needs of various users under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating,” “accessing,” “adding,” “aggregating,” “alerting,” “applying,” “analyzing,” “associating,” “calculating,” “capturing,” “categorizing,” “classifying,” “comparing,” “creating,” “defining,” “detecting,” “determining,” “distributing,” “eliminating,” “encrypting,” “extracting,” “filtering,” “forwarding,” “generating,” “identifying,” “implementing,” “informing,” “monitoring,” “obtaining,” “posting,” “processing,” “providing,” “receiving,” “requesting,” “saving,” “sending,” “storing,” “substituting,” “transferring,” “transforming,” “transmitting,” “using,” etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general-purpose system selectively activated or configured/reconfigured by a computer program stored on a computer program product as discussed herein that can be accessed by a computing system or other device.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for identifying potential fraud activity in a tax return preparation system to trigger an identity verification challenge through the tax return preparation system, comprising:
using one or more computing systems to provide a tax return preparation system to one or more users of the tax return preparation system;
using one or more computing systems to generate potential fraud analytics model data representing a potential fraud analytics model for determining a user potential fraud risk score to be associated with tax return content data included in tax return data representing tax returns associated with users of the tax return preparation system, the user potential fraud risk score representing a likelihood of potential fraud activity associated with tax return content data;
using one or more computing systems to receive user tax return content data associated with user tax return data representing a user tax return associated with a user of the one or more users of the tax return preparation system, the user tax return content data representing tax return content associated with the user tax return data to be submitted by the user, the user tax return content data including user characteristics data representing user characteristics associated with the user and user financial information data representing financial information associated with the user;
using one or more computing systems to process the user tax return content data using the analytics model to determine a user potential fraud risk score to be associated with the user tax return content data, the user potential fraud risk score representing a likelihood of potential fraud activity associated with the user tax return content data;
using one or more computing systems to generate user potential fraud risk score data representing the determined user potential fraud risk score;
using one or more computing systems to compare the user potential fraud risk score represented by the user potential fraud risk score data to a defined threshold user potential fraud risk score represented by user potential fraud risk score threshold data to determine if the user potential fraud risk score exceeds a user potential fraud risk score threshold;
using one or more computing systems to determine the user potential fraud risk score exceeds the user potential fraud risk score threshold;
using one or more computing systems to generate user identity verification challenge data representing one or more identity verification challenges to be provided to the user through the tax return preparation system, the one or more identity verification challenges requiring correct identity verification challenge response data from the user representing correct responses to the identity verification challenges;
using one or more computing systems to provide the user identity verification challenge data to the user through the tax return preparation system;
using one or more computing systems to delay submission of the user tax return associated with the user tax return content data until correct identity verification challenge response data is received from the user representing correct responses to the identity verification challenges; and
only upon receiving correct identity verification challenge response data from the user representing correct responses to the identity verification challenges, using one or more computing systems to allow submission of the user tax return data representing the user tax return associated with the user tax return content data.

2. The computing system implemented method of claim 1 further comprising:
upon receiving incorrect identity verification challenge response data from the user representing incorrect responses to the identity verification challenges, or not receiving any identity verification challenge response data from the user after a defined period of time:
using one or more computing systems to prevent submission of the user tax return data representing the user tax return associated with the user tax return content data and taking one or more risk reduction actions.

3. The computing system implemented method of claim 2 wherein the one or more risk reduction actions include one or more of:
transmitting one or more messages to email accounts that are determined to be associated with a legitimate user for the tax return;
collecting evidence from the user to verify that the user is the legitimate user for the tax return; and
enabling the legitimate user to cancel a request to file the tax return with one or more federal and state revenue agencies to prevent a fraudulent tax return from being filed by a fraudulent user.

4. The computing system implemented method of claim 1, further comprising:
generating receiver operating characteristics data representing receiver operating characteristics of the analytics model; and
determining the user potential fraud risk score threshold at least partially based on the receiver operating characteristics of the analytics model to determine an acceptable quantity of error.

5. The computing system implemented method of claim 1, wherein the user potential fraud risk score is a combination of individual scores for a plurality of risk categories.

6. The computing system implemented method of claim 5, wherein the plurality of risk categories is selected from a group of risk categories, comprising:
refund amount;
percentage of withholdings;
total sum of wages claimed;
occupation;
occupations included in tax returns filed from a particular computing system;
likelihood of falsified numbers included in the tax return content;
phone numbers;
a number of states claimed in the tax return;
a complexity of a tax return;
a number of dependents;
an age of dependents;
an age of user; and
an age of a spouse of the user.

7. The computing system implemented method of claim 1, further comprising:
receiving system access information data for the tax return associated with the user, the system access information data representing system access records of one or more user computing systems that were used to prepare the tax return in the tax return preparation system, the system access records being stored in memory allocated for use by the security system; and
applying the system access information data to the analytics model data with the tax return content data to generate the user potential fraud risk score data.

8. The computing system implemented method of claim 7, wherein the system access information data includes one or more of:
an operating system used by a user computing system to access the tax return preparation system to provide the tax return content data;
a hardware identifier of a user computing system to access the tax return preparation system to provide the tax return content data; and
a web browser used by a user computing system to access the tax return preparation system to provide the tax return content data.

9. The computing system implemented method of claim 8, wherein the system access information data includes one or more of:
data representing an age of a user account for the tax return preparation system;
data representing features or characteristics associated with an interaction between a user computing system and the tax return preparation system;
data representing a web browser of a user computing system;
data representing an operating system of a user computing system;
data representing a media access control address of a user computing system;
data representing user credentials used to access a user account;
data representing a user account;
data representing a user account identifier;
data representing an IP address of a user computing system; and
data representing characteristics of an IP address of the user computing system.

10. The computing system implemented method of claim 1, further comprising:
receiving fraudulent activity data representing a plurality of fraudulently filed tax returns; and
training the analytics model data at least partially based on the fraudulent activity data.

11. The computing system implemented method of claim 10, wherein training the analytics model data includes applying an analytics model training operation to fraudulent activity data, the analytics model training operation being selected from a group of analytics model training operations, consisting of:
regression;
logistic regression;
decision trees;
artificial neural networks;
support vector machines;
linear regression;
nearest neighbor methods;
distance based methods;
naive Bayes;
linear discriminant analysis; and
k-nearest neighbor algorithm.

12. The computing system implemented method of claim 1, wherein the user characteristics data and the financial information data are selected from a group of user characteristics data and financial information data, consisting of:
data indicating an age of the user;
data indicating an age of a spouse of the user;
data indicating a zip code;
data indicating a tax return filing status;
data indicating state income;
data indicating a home ownership status;
data indicating a home rental status;
data indicating a retirement status;
data indicating a student status;
data indicating an occupation of the user;
data indicating an occupation of a spouse of the user;
data indicating whether the user is claimed as a dependent;
data indicating whether a spouse of the user is claimed as a dependent;
data indicating whether another taxpayer is capable of Claiming the user as a dependent;
data indicating whether a spouse of the user is capable of being claimed as a dependent;
data indicating salary and wages;
data indicating taxable interest income;
data indicating ordinary dividend income;
data indicating qualified dividend income;
data indicating business income;
data indicating farm income;
data indicating capital gains income;
data indicating taxable pension income;
data indicating pension income amount;
data indicating IRA distributions;
data indicating unemployment compensation;
data indicating taxable IRA;
data indicating taxable Social Security income;
data indicating amount of Social Security income;
data indicating amount of local state taxes paid;
data indicating whether the user filed a previous years' federal itemized deduction;
data indicating whether the user filed a previous years' state itemized deduction; and
data indicating whether the user is a returning user to a tax return preparation system;
data indicating an annual income;
data indicating an employer's address;
data indicating contractor income;
data indicating a marital status;
data indicating a medical history;
data indicating dependents;
data indicating assets;
data indicating spousal information;
data indicating children's information;
data indicating an address;
data indicating a name;
data indicating a Social Security Number;
data indicating a government identification;
data indicating a date of birth;
data indicating educator expenses;
data indicating health savings account deductions;
data indicating moving expenses;
data indicating IRA deductions;
data indicating student loan interest deductions;
data indicating tuition and fees;
data indicating medical and dental expenses;
data indicating state and local taxes;
data indicating real estate taxes;
data indicating personal property tax;
data indicating mortgage interest;
data indicating charitable contributions;
data indicating casualty and theft losses;
data indicating unreimbursed employee expenses;
data indicating an alternative minimum tax;
data indicating a foreign tax credit;
data indicating education tax credits;
data indicating retirement savings contributions; and
data indicating child tax credits.

13. A computing system implemented method for identifying potential fraud activity in a tax return preparation system to trigger an identity verification challenge through the tax return preparation system, comprising:
using one or more computing systems to provide a tax return preparation system to one or more users of the tax return preparation system;
using one or more computing systems to store prior tax return content data associated with prior tax return data representing prior tax returns submitted by one or more users of the tax return preparation system;
using one or more computing systems to generate potential fraud analytics model data representing a potential fraud analytics model for determining a user potential fraud risk score to be associated with tax return content data included in tax return data representing tax returns associated with users of the tax return preparation system, the user potential fraud risk score representing a likelihood of potential fraud activity associated with new user tax returns associated with the tax filer identifier at least partially based on tax return history for the tax filer identifier;
using one or more computing systems to receive new user tax return content data associated with new user tax return data representing a new user tax return to be submitted by a user of the tax return preparation system, the user of the tax return preparation system being associated with a tax filer identifier, the new user tax return content data representing new user tax return content for the new user tax return;
using one or more computing systems to obtain from the prior tax return content data relevant prior tax return content data of one or more relevant prior tax returns for the tax filer identifier, wherein the one or more relevant prior tax returns are tax returns filed individually or jointly using the tax filer identifier;
using one or more computing systems to analyze the new tax return content data and the relevant prior tax return content data using the analytics model to determine user potential fraud risk score data representing a user potential fraud risk score for the new tax return for the tax filer identifier, the user potential fraud risk score representing a likelihood of potential fraud activity associated with the new tax return for the tax filer identifier at least partially based on tax return history for the tax filer identifier;
using one or more computing systems to generate user potential fraud risk score data representing the determined user potential fraud risk score;
using one or more computing systems to compare the user potential fraud risk score represented by the user potential fraud risk score data to a defined threshold user potential fraud risk score represented by user potential fraud risk score threshold data to determine if the user potential fraud risk score exceeds a user potential fraud risk score threshold;
using one or more computing systems to determine the user potential fraud risk score exceeds the user potential fraud risk score threshold;
using one or more computing systems to generate user identity verification challenge data representing one or more identity verification challenges to be provided to the user through the tax return preparation system, the one or more identity verification challenges requiring correct identity verification challenge response data from the user representing correct responses to the identity verification challenges;
using one or more computing systems to provide the user identity verification challenge data to the user through the tax return preparation system;
using one or more computing systems to delay submission of the new user tax return associated with the new user tax return content data until correct identity verification challenge response data is received from the user representing correct responses to the identity verification challenges; and
only upon receiving correct identity verification challenge response data from the user representing correct responses to the identity verification challenges, using one or more computing systems to allow submission of the new user tax return data representing the new user tax return associated with the new user tax return content data.

14. The computing system implemented method of claim 13, wherein the tax filer identifier is selected from a group of tax filer identifiers, consisting of:
a Social Security Number (“SSN”);
an Individual Taxpayer Identification Number (“ITIN”);
an Employer Identification Number (“EIN”);
an Internal Revenue Service Number (“IRSN”);
a foreign tax identification number;
a name;
a date of birth;
a passport number;
a driver's license number;
a green card number; and
a visa number.

15. The computing system implemented method of claim 13, wherein the new user tax return is prepared with a new user account for the tax return preparation system and the one or more relevant prior tax returns were prepared with at least one of a plurality of prior user accounts for the tax return preparation system.

16. The computing system implemented method of claim 13 further comprising:
upon receiving incorrect identity verification challenge response data from the user representing incorrect responses to the identity verification challenges, or not receiving any identity verification challenge response data from the user after a defined period of time:
using one or more computing systems to prevent submission of the new user tax return data representing the new user tax return associated with the new user tax return content data and taking one or more risk reduction actions.

17. The computing system implemented method of claim 16 wherein the one or more risk reduction actions include one or more of:
transmitting one or more messages to email accounts that are determined to be associated with a legitimate user for the tax return;
collecting evidence from the user to verify that the user is the legitimate user for the tax return; and
enabling the legitimate user to cancel a request to file the tax return with one or more federal and state revenue agencies to prevent a fraudulent tax return from being filed by a fraudulent user.

18. The computing system implemented method of claim 13, further comprising:
generating receiver operating characteristics data representing receiver operating characteristics of the analytics model; and
determining the user potential fraud risk score threshold at least partially based on the receiver operating characteristics of the analytics model to determine an acceptable quantity of error.

19. The computing system implemented method of claim 13, wherein the user potential fraud risk score is a combination of individual scores for a plurality of risk categories.

20. The computing system implemented method of claim 19, wherein each of the plurality of risk categories is selected from a group of risk categories, comprising:
a number of dependents;
a refund amount;
a bank account for receiving tax refunds for the new tax return;
a percentage of withholdings;
a total sum of wages claimed;
an occupation;
occupations included in tax returns filed from a particular computing system;
a likelihood of falsified numbers included in the new tax return content;
phone numbers;
a number of states claimed in the new tax return;
a complexity of the new tax return;
an age of dependents;
an age of user; and
an age of a spouse of the user.

21. The computing system implemented method of claim 13, further comprising:
receiving system access information data for the new user tax return, the system access information data representing system access records of one or more user computing systems that were used to prepare the new user tax return in the tax return preparation system, the system access records being stored in memory allocated for use by the security system; and
applying the system access information data to the analytics model data with the new user tax return content data to generate the user potential fraud risk score data.

22. The computing system implemented method of claim 21, wherein the system access information data includes one or more of:
an operating system used by a user computing system to access the tax return preparation system to provide the new user tax return content data;
a hardware identifier of a user computing system used to access the tax return preparation system to provide the new user tax return content data; and
a web browser used by a user computing system to access the tax return preparation system to provide the new user tax return content data.

23. The computing system implemented method of claim 21, wherein the system access information data includes one or more of:
data representing an age of a user account for the tax return preparation system;
data representing features or characteristics associated with an interaction between a user computing system and the tax return preparation system;
data representing a web browser of a user computing system;
data representing an operating system of a user computing system;
data representing a media access control address of a user computing system;
data representing user credentials used to access a user account;
data representing a user account;
data representing a user account identifier;
data representing an IP address of a user computing system; and
data representing characteristics of an IP address of the user computing system.

24. The computing system implemented method of claim 13, further comprising:
receiving fraudulent activity data representing a plurality of fraudulently filed tax returns; and
training the analytics model data at least partially based on the fraudulent activity data.

25. The computing system implemented method of claim 24, wherein training the analytics model data includes applying an analytics model training operation to the fraudulent activity data, the analytics model training operation being selected from a group of analytics model training operations, consisting of:
regression;
logistic regression;
decision trees;
artificial neural networks;
support vector machines;
linear regression;
nearest neighbor methods;
distance based methods;
naive Bayes;
linear discriminant analysis; and
k-nearest neighbor algorithm.

26. The computing system implemented method of claim 13, wherein the new user tax return content data includes user characteristics data representing user characteristics of a user of the tax return preparation system and user financial information data representing financial information for the user of the tax return preparation system.

27. The computing system implemented method of claim 26, wherein the user characteristics data and the user financial information data include one or more of:
data indicating an age of the user of the tax return preparation system;
data indicating an age of a spouse of the user of the tax return preparation system;
data indicating a zip code;
data indicating a tax return filing status;
data indicating state income;
data indicating a home ownership status;
data indicating a home rental status;
data indicating a retirement status;
data indicating a student status;
data indicating an occupation of the user of the tax return preparation system;
data indicating an occupation of a spouse of the user of the tax return preparation system;
data indicating whether the user is claimed as a dependent;
data indicating whether a spouse of the user is claimed as a dependent;
data indicating whether another taxpayer is capable of Claiming the user of the tax return preparation system as a dependent;
data indicating whether a spouse of the user of the tax return preparation system is capable of being claimed as a dependent;
data indicating salary and wages;
data indicating taxable interest income;
data indicating ordinary dividend income;
data indicating qualified dividend income;
data indicating business income;
data indicating farm income;
data indicating capital gains income;
data indicating taxable pension income;
data indicating pension income amount;
data indicating IRA distributions;
data indicating unemployment compensation;
data indicating taxable IRA;
data indicating taxable Social Security income;
data indicating amount of Social Security income;
data indicating amount of local state taxes paid;
data indicating whether the user of the tax return preparation system filed a previous years' federal itemized deduction;
data indicating whether the user of the tax return preparation system filed a previous years' state itemized deduction; and
data indicating whether the user of the tax return preparation system is a returning user to a tax return preparation system;
data indicating an annual income;
data indicating an employer's address;
data indicating contractor income;
data indicating a marital status;
data indicating a medical history;
data indicating dependents;
data indicating assets;
data indicating spousal information;
data indicating children's information;
data indicating an address;
data indicating a name;
data indicating a Social Security Number;
data indicating a government identification;
data indicating a date of birth;
data indicating educator expenses;
data indicating health savings account deductions;
data indicating moving expenses;
data indicating IRA deductions;
data indicating student loan interest deductions;
data indicating tuition and fees;
data indicating medical and dental expenses;
data indicating state and local taxes;
data indicating real estate taxes;
data indicating personal property tax;
data indicating mortgage interest;
data indicating charitable contributions;
data indicating casualty and theft losses;
data indicating unreimbursed employee expenses;
data indicating an alternative minimum tax;
data indicating a foreign tax credit;
data indicating education tax credits;
data indicating retirement savings contributions; and
data indicating child tax credits.

28. A computing system implemented method for identifying potential fraud activity in a tax return preparation system to trigger an identity verification challenge through the tax return preparation system, comprising:
using one or more computing systems to provide a tax return preparation system to one or more users of the tax return preparation system;
using one or more computing systems to generate potential fraud analytics model data representing a potential fraud analytics model for determining a user potential fraud risk score to be associated with tax return content data included in tax return data representing tax returns associated with users of the tax return preparation system, the user potential fraud risk score representing a likelihood of potential fraud activity associated with the tax return for the tax filer identifier at least partially based on the user data entry characteristics for the tax return;
using one or more computing systems to receive new user tax return content data associated with new user tax return data representing a new user tax return to be submitted by a user of the tax return preparation system, the user of the tax return preparation system being associated with a tax filer identifier, the new user tax return content data representing new user tax return content for the new user tax return;
using one or more computing systems to identify user data entry characteristics data for the new user tax return content data, the user data entry characteristics data representing data entry characteristics for entry of the new user tax return content into the tax return preparation system;
using one or more computing systems and the analytics model data to determine a user potential fraud risk score representing a user potential fraud risk score for the new tax return for the tax filer identifier, the user potential fraud risk score representing a likelihood of potential fraud activity associated with the new tax return for the tax filer identifier at least partially based on the data entry characteristics for the new tax return;
using one or more computing systems to generate user potential fraud risk score data representing the determined user potential fraud risk score;
using one or more computing systems to compare the user potential fraud risk score represented by the user potential fraud risk score data to a defined threshold user potential fraud risk score represented by user potential fraud risk score threshold data to determine if the user potential fraud risk score exceeds a user potential fraud risk score threshold;
using one or more computing systems to determine the user potential fraud risk score exceeds the user potential fraud risk score threshold;
using one or more computing systems to generate user identity verification challenge data representing one or more identity verification challenges to be provided to the user through the tax return preparation system, the one or more identity verification challenges requiring correct identity verification challenge response data from the user representing correct responses to the identity verification challenges;
using one or more computing systems to provide the user identity verification challenge data to the user through the tax return preparation system;
using one or more computing systems to delay submission of the new user tax return associated with the new user tax return content data until correct identity verification challenge response data is received from the user representing correct responses to the identity verification challenges; and
only upon receiving correct identity verification challenge response data from the user representing correct responses to the identity verification challenges, using one or more computing systems to allow submission of the new user tax return data representing the new user tax return associated with the new user tax return content data.

29. The computing system implemented method of claim 28, wherein the user data entry characteristics include one or more of:
tabbing to progress through input fields of the tax return preparation system;
clicking to progress through input fields of the tax return preparation system;
pasting the new tax return content into input fields of the tax return preparation system;
typing the new tax return content into input fields of the tax return preparation system;
using a script to insert the new tax return content into input fields of the tax return preparation system;
speed of entering the new tax return content into input fields of the tax return preparation system;
characteristics of mouse cursor progression between input fields of the tax return preparation system;
total amount of mouse cursor movement within the tax return preparation system;
consistency in duration of mouse clicks from a user;
duration of mouse clicks;
consistency of location of mouse clicks within input fields of the tax return preparation system;
which ones of a plurality of user experience pages the user accesses;
an order in which some of a plurality of user experience pages are accessed; and
duration of access of individual ones of user experience pages.

30. The computing system implemented method of claim 29, wherein the group of user data entry characteristics are used to distinguish script-based entry of the new tax return content data from manual entry of the new tax return content.

31. The computing system implemented method of claim 29, further comprising:
determining the speed of entering new tax return content into input fields of the tax return preparation system;
comparing the speed to a predetermined speed threshold; and
executing risk reduction instructions if the speed exceeds the predetermined speed threshold.

32. The computing system implemented method of claim 31, wherein the predetermined speed threshold is determined with one or more of the analytics model and one or more additional analytics models at least partially based on one or more training data sets.

33. The computing system implemented method of claim 28, wherein the user potential fraud risk score represents a likelihood that a script was used to provide the new tax return content data to the tax return preparation system.

34. The computing system implemented method of claim 28, wherein the tax filer identifier includes one or more of:
a Social Security Number (“SSN”);
an Individual Taxpayer Identification Number (“ITIN”);
an Employer Identification Number (“EIN”);
an Internal Revenue Service Number (“IRSN”);
a foreign tax identification number;
a name;
a date of birth;
a passport number;
a driver's license number;
a green card number; and
a visa number.

35. The computing system implemented method of claim 28 wherein the one or more identity verification challenges include one or more of:
requests to identify or submit historical or current residences occupied by the legitimate account holder/user;
requests to identify or submit one or more historical or current loans or credit accounts associated with the legitimate account holder/user;
requests to identify or submit full or partial names of relatives associated with the legitimate account holder/user;
requests to identify or submit recent financial activity conducted by the legitimate account holder/user; requests to identify or submit phone numbers or social media account related information associated with the legitimate account holder/user;
requests to identify or submit full or partial names of relatives associated with the legitimate account holder/user;
requests to identify or submit current or historical automobile, teacher, pet, friend, or nickname information associated with the legitimate account holder/user; and
any Multi-Factor Authentication (MFA) challenge.

36. The computing system implemented method of claim 28 further comprising:
upon receiving incorrect identity verification challenge response data from the user representing incorrect responses to the identity verification challenges, or not receiving any identity verification challenge response data from the user after a defined period of time, using one or more computing systems to prevent submission of the new user tax return data representing the new user tax return associated with the new user tax return content data and taking one or more risk reduction actions.

37. The computing system implemented method of claim 36 wherein the one or more risk reduction actions include one or more of:
transmitting one or more messages to email accounts that are determined to be associated with a legitimate user for the tax return;
collecting evidence from the user to verify that the user is the legitimate user for the new tax return; and
enabling the legitimate user to cancel a request to file the new tax return with one or more federal and state revenue agencies to prevent a fraudulent tax return from being filed by a fraudulent user.

38. The computing system implemented method of claim 36, wherein the analytics model identifies one or more patterns of data entry characteristics that are associated with potentially fraudulent activity.

39. The computing system implemented method of claim 28, wherein the user potential fraud risk score is a combination of individual scores for a plurality of risk categories.

40. The computing system implemented method of claim 39, wherein each of the plurality of risk categories is selected from a group of risk categories, comprising:
script-based data entry;
a number of dependents;
a refund amount;
a bank account for receiving tax refunds for the new tax return;
a percentage of withholdings;
a total sum of wages claimed;
an occupation;
occupations included in tax returns filed from a particular computing system;
a likelihood of falsified numbers included in the new tax return content;
phone numbers;
a number of states claimed in the new tax return;
a complexity of the new tax return;
an age of dependents;
an age of user; and
an age of a spouse of the user.

41. The computing system implemented method of claim 28, further comprising:
receiving system access information data for the new tax return, the system access information data representing system access records of one or more user computing systems that were used to prepare the new tax return in the tax return preparation system, the system access records being stored in memory allocated for use by the security system; and
applying the system access information data to the analytics model data with the new tax return content data to generate the user potential fraud risk score data.

42. The computing system implemented method of claim 41, wherein the system access information data includes one or more of:
an operating system used by a user computing system to access the tax return preparation system to provide the new tax return content data;
a hardware identifier of a user computing system used to access the tax return preparation system to provide the new tax return content data; and
a web browser used by a user computing system to access the tax return preparation system to provide the new tax return content data.

43. The computing system implemented method of claim 41, wherein the system access information data includes one or more of:
data representing an age of a user account for the tax return preparation system;
data representing features or characteristics associated with an interaction between a user computing system and the tax return preparation system;
data representing a web browser of a user computing system;
data representing an operating system of a user computing system;
data representing a media access control address of a user computing system;
data representing user credentials used to access a user account;
data representing a user account;
data representing a user account identifier;
data representing an IP address of a user computing system; and
data representing characteristics of an IP address of the user computing system.

44. The computing system implemented method of claim 28, further comprising:
receiving prior user data entry characteristics data for prior tax return content data for a plurality of tax filer identifiers, the prior user data entry characteristics data representing prior data entry characteristics for prior tax return content for the plurality of tax filer identifiers; and
training the analytics model data at least partially based on the prior user data entry characteristics data.

45. The computing system implemented method of claim 44, wherein training the analytics model data includes applying an analytics model training operation to the prior user data entry characteristics data, the analytics model training operation being selected from a group of analytics model training operations, consisting of:
regression;
logistic regression;
decision trees;
artificial neural networks;
support vector machines;
linear regression;
nearest neighbor methods;
distance based methods;
naive Bayes;
linear discriminant analysis; and
k-nearest neighbor algorithm.

46. The computing system implemented method of claim 28, wherein the new tax return content data includes user characteristics data representing user characteristics of the tax filer identifier and financial information data representing financial information for the tax filer identifier.

47. The computing system implemented method of claim 46, wherein the user characteristics data and the financial information data are selected from a group of user characteristics data and financial information data, consisting of:
data indicating an age of the user of the tax return preparation system;
data indicating an age of a spouse of the user of the tax return preparation system;
data indicating a zip code;
data indicating a tax return filing status;
data indicating state income;
data indicating a home ownership status;
data indicating a home rental status;
data indicating a retirement status;
data indicating a student status;
data indicating an occupation of the user of the tax return preparation system;
data indicating an occupation of a spouse of the user of the tax return preparation system;
data indicating whether the user is claimed as a dependent;
data indicating whether a spouse of the user is claimed as a dependent;
data indicating whether another taxpayer is capable of Claiming the user of the tax return preparation system as a dependent;
data indicating whether a spouse of the user of the tax return preparation system is capable of being claimed as a dependent;
data indicating salary and wages;
data indicating taxable interest income;
data indicating ordinary dividend income;
data indicating qualified dividend income;
data indicating business income;
data indicating farm income;
data indicating capital gains income;
data indicating taxable pension income;
data indicating pension income amount;
data indicating IRA distributions;
data indicating unemployment compensation;
data indicating taxable IRA;
data indicating taxable Social Security income;
data indicating amount of Social Security income;
data indicating amount of local state taxes paid;
data indicating whether the user of the tax return preparation system filed a previous years' federal itemized deduction;
data indicating whether the user of the tax return preparation system filed a previous years' state itemized deduction; and
data indicating whether the user of the tax return preparation system is a returning user to a tax return preparation system;
data indicating an annual income;
data indicating an employer's address;
data indicating contractor income;
data indicating a marital status;
data indicating a medical history;
data indicating dependents;
data indicating assets;
data indicating spousal information;
data indicating children's information;
data indicating an address;
data indicating a name;
data indicating a Social Security Number;
data indicating a government identification;
data indicating a date of birth;
data indicating educator expenses;
data indicating health savings account deductions;
data indicating moving expenses;
data indicating IRA deductions;
data indicating student loan interest deductions;
data indicating tuition and fees;
data indicating medical and dental expenses;
data indicating state and local taxes;
data indicating real estate taxes;
data indicating personal property tax;
data indicating mortgage interest;
data indicating charitable contributions;
data indicating casualty and theft losses;
data indicating unreimbursed employee expenses;
data indicating an alternative minimum tax;
data indicating a foreign tax credit;
data indicating education tax credits;
data indicating retirement savings contributions; and
data indicating child tax credits.
